(19) United States
(12) Patent Application Publication
(10) Pub. No.: US 2026/0175503 A1
(43) Pub. Date: Jun. 25, 2026

(54) Thermoplastic Vulcanizate Compositions Including Cyclic Olefin Polymers

(71) Applicant: Celanese International Corporation, Irving, TX (US)

(72) Inventors: Krishnan Anantha Narayana Iyer, Manvel, TX (US); Shushuang Li, Shanghai (CN); Anas Mujtaba, Kraainem (BE); Vincent F. Rerat, Obourg (BE); Yujie Sheng, Shanghai (CN); Liang Li, Shanghai (CN); Dinara R. Sunagatullina, Houston, TX (US)

(21) Appl. No.: 19/540,868

(22) Filed: Feb. 16, 2026

Related U.S. Application Data
(63) Continuation of application No. 18/262,581.
(60) Provisional application No. 63/147,390, filed on Feb. 9, 2021.

(51) Int. Cl. B29C 48/00; B29C 48/09; B29L 31/26

(52) U.S. Cl. CPC B29C 48/022; B29C 48/0022; B29C 48/09; B29C 2791/003; B29C 2793/0072; B29L 2031/265

(57) ABSTRACT

Described herein are thermoplastic vulcanizate compositions that include a thermoplastic matrix comprising a cyclic olefin copolymer and an oil and particles dispersed in the thermoplastic matrix and comprising an at least partially cross-linked rubber. The thermoplastic vulcanizate composition has a tan δ profile comprising a peak occurring between about −20° C. and about 90

### CROSS REFERENCE TO RELATED APPLICATIONS

This is a continuation of U.S. Ser. No. 18/262,581 filed on Jul. 24, 2023, which is a national phase entry under 35 USC 371 International Patent Application No. PCT/US2021/056527 filed on Oct. 26, 2021, which claims the priority benefit of U.S. Ser. No. 63/147,390, filed Feb. 9, 2021, which is incorporated herein by reference.

### FIELD OF INVENTION

Embodiments of the present invention generally relate to thermoplastic vulcanizate compositions comprising cyclic olefin copolymers for improved vibration damping properties.

### BACKGROUND

This section is intended to provide relevant background information to facilitate a better understanding of the various aspects of the described embodiments. Accordingly, it should be understood that these statements are to be read in this light and not as admissions of prior art.

Thermoplastic vulcanizates (TPVs) comprise finely-divided rubber particles dispersed within a thermoplastic matrix. These rubber particles are advantageously cross-linked to promote elasticity. The dispersed rubber phase is typically referred to as the discontinuous phase or rubber phase, and the thermoplastic phase is referred to as the continuous phase or plastic phase. Such TPVs may be prepared by dynamic vulcanization, which is a process whereby a rubber is cured or vulcanized using a curative agent within a blend with at least one thermoplastic polymer while the polymers are undergoing mixing or masticating at some elevated temperature, preferably above the melt temperature of the thermoplastic polymer. TPVs thus have the benefit of the elastomeric properties provided by the elastomeric phase, with the processability of thermoplastics provided by the thermoplastic phase.

With elastomeric properties, TPVs demonstrate potential applications for vibration damping. Materials having vibration damping properties are used for a variety of applications such as building materials, electrical and electronic appliances, optical instruments, audiovisual equipment, railways, and automotive vehicles. Typical vibration damping materials include low-hardness products having gel-like properties. In recent years, there has been an increased interest in developing new materials with improved vibration damping properties for use in electric motors that are used in hybrid vehicles (HV), plug-in hybrid vehicles (PHV), fuel cell vehicles (FCV), and electric vehicles (EV). Such vehicles produce little to no engine noise during driving. Accordingly, noise entering from outside the vehicle can be more noticeable and appear magnified. Thus, there is an increased need for decreasing the external ambient noise as compared to a conventional vehicle. Also, typical operating temperatures for electric vehicles are in the range of 0-90° C. Hence, TPVs useful for these applications require vibration damping properties in the range of 0-90° C.

TPVs have successfully replaced rubber in several areas, but thermoset rubbers still outperform TPVs with respect to compression set. Compression set testing measures the ability of an elastic material to return to its original thickness after prolonged compressive stresses at a given temperature and deflection. As an elastic material is compressed over time, it loses its ability to return to its original thickness. Accordingly, it is preferred that the elastomer compositions described herein exhibit relatively low compression set percentage, as the percentage measurement is a measure of the compositions ability to recover its original thickness. That is, if the composition is compressed and does not recover at all, it would have a 100% compression set, and if it recovered completely to its original thickness, it would have a 0% compression set. That is, the smaller the compression set value, the longer the life cycle of the composition and its effective use. In TPVs having an ethylene-propylene-diene (EPDM) rubber polymer that is cured less than about 90 percent, compression set is generally unacceptably high for many applications, especially at elevated temperatures. In addition, the thermoplastic matrix tends to decrease resistance to compression set at lower temperatures. The difference between polypropylene (PP)/EPDM TPV and EPDM rubbers is the semi-crystalline PP matrix. While the PP matrix gives TPVs melt-processability and thermal resistance, its crystallinity also limits the elastic behavior of the TPV. The dynamic transition of crystalline microstructures in the PP matrix under heating and stress causes TPVs to have higher compression sets than EPDM rubbers. The deformation mechanism of TPV is restricted by yielding of the semi-crystalline PP matrix, preventing the TPV from fully utilizing the elastic limit of the EPDM phase. In addition to elastic properties (low compression set, tension set, and high resiliency), the TPVs should maintain a balance of other mechanical properties including hardness, tensile properties (e.g., tensile strength, modulus, elongation to break) as well as extrusion performance including processability and part surface appearance (e.g., smoothness, no edge tear, no surface spots, no die lines, no Rococo). Current combinations of EPDMs and thermoplastic polyolefins employed have proved to be inadequate for these purposes.

There is thus a need to develop a TPV composition with superior vibration damping properties in the range of 0-90° C. and superior elastic properties.

### SUMMARY

Disclosed is a thermoplastic vulcanizate composition comprising a thermoplastic matrix, which comprises a cyclic olefin copolymer and an oil. Cross-linked rubber particles are dispersed in the thermoplastic matrix. The TPV composition has a vibration damping peak occurring between about −20 and about 90° C.

A thermoplastic vulcanizate composition is also disclosed which comprises a reaction product of dynamically curing a composition comprising a rubber, a cross-linker, a thermoplastic resin comprising a cyclic olefin copolymer, and an oil. The thermoplastic vulcanizate composition has a vibration damping peak occurring between about −20° C. and about 90° C.

A thermoplastic vulcanizate composition is also disclosed which comprises: (1) a dynamically cured rubber comprising an ethylene propylene diene (EPDM) polymer or a brominated isobutyl paramethyl-styrene (BIMSM) polymer, (2) a thermoplastic resin in an amount from about 20 to about 500 parts by weight per 100 parts rubber (about 20 to about 500 phr) and comprising from about 1 wt % to about 100 wt % of a cyclic olefin copolymer having a glass transition temperature (Tg) of at least about 30° C. and up to 99 wt % of a semi-crystalline acyclic polyolefin, and (3) an oil in an amount from about 50 to about 250 parts by weight per 100 parts rubber (about 50 to about 250 phr). The thermoplastic vulcanizate composition has a tan δ profile comprising a peak value between about 0.1 and about 2.0 occurring between about −20° C. and about 90° C. The thermoplastic vulcanizate composition has a compression set of between about 15% and about 50% at 70° C. after 22 hr of compression and a hardness between about 15 and about 95 measured on a Shore A durometer hardness scale at 15 sec after indentation, and a hardness between about 15 and about 50 measured on a Shore D durometer hardness scale at 15 sec after indentation.

### BRIEF DESCRIPTION OF THE DRAWINGS

Embodiments of the thermoplastic vulcanizate compositions including cyclic olefin copolymers are described with reference to the following figures. The same numbers are used throughout the figures to reference like features and components. The features depicted in the figures are not necessarily shown to scale. Certain features of the embodiments may be shown exaggerated in scale or in somewhat schematic form, and some details of elements may not be shown in the interest of clarity and conciseness.

FIG. 1 is a graph of loss tangent (tan δ) vs. temperature for TPV compositions of Example 1, according to one or more embodiments.

FIG. 2 is a graph of loss tangent vs. temperature for TPV compositions of Example 2, according to one or more embodiments.

FIG. 3A is a graph of hardness vs. cyclic olefin copolymer content for TPV compositions, according to one or more embodiments. FIG. 3B is a graph of glass transition temperature (Tg) vs. norbornene content for neat cyclic olefin copolymers and TPV compositions, according to one or more embodiments.

FIG. 4 is a micrograph of Comparative 1.

FIGS. 5A, 5B, and 5C are micrographs of TPV compositions, according to one or more embodiments.

### DETAILED DESCRIPTION

Various specific embodiments, versions of the present invention will now be described, including definitions that are adopted herein. While the following detailed description gives specific embodiments, those skilled in the art will appreciate that these embodiments are exemplary only, and that components of the embodiments may be interchangeable if appropriate and that the present invention can be practiced in other ways. Any reference to the “invention” may refer to one or more, but not necessarily all, of the present inventions defined by the claims. The use of headings is for purposes of convenience only and does not limit the scope of the present invention.

### Definitions

The term “phr” means “parts per hundred rubber” and refers to the amount of a component included in a thermoplastic vulcanizate composition, expressed as a number of parts per hundred parts of rubber, wherein the parts are determined by weight. Phr typically indicates the amount of a component before any curing processes. However, for the purposes of this disclosure, curing processes have negligible impact on the weights and amounts of all components, such that a phr specified before any curing process is substantially the same as a phr specified during or after any curing process. As such, phr in this disclosure may refer equivalently to phr before, during, or after any curing process.

“Amorphous cycloolefin polymer” and like terminology refers to a COP or COC which exhibits a glass transition temperature, but does not exhibit a crystalline melting temperature nor does it exhibit a clear x-ray diffraction pattern.

“COC” and like terminology refers to a cycloolefin copolymer (also referred to herein as a cyclic olefin copolymer) prepared with acyclic olefin monomers and cycloolefin monomers by way of addition copolymerization.

“COP” and like terminology refers to a cycloolefin polymer (also referred to herein as a cyclic olefin polymer) prepared exclusively from cycloolefin monomers, typically by ring opening polymerization.

Cyclic olefins (also referred to herein as cycloolefins) are defined herein as olefins where at least one double bond is contained in one or more alicyclic rings. Cyclic olefins may also have acyclic double bonds in side chains.

Dienes are defined herein broadly as including any olefin containing at least two acyclic double bonds. They may also contain aromatic substituents. If one or more of the double bonds of diene is contained in an alicyclic ring, the monomer is herein classified as a cyclic olefin.

Delta hardness is defined as the difference between Shore A hardness measured at 1 s and 15 s delay after indentation.

### TPV Composition Properties

The inventors have discovered that TPV compositions incorporating cyclic olefin copolymers (COCs) prepared with acyclic olefin monomers and cyclic olefin monomers can demonstrate superior vibration damping performance and elastic performance compared to TPVs without COCs as well as compared to traditional EPDM rubbers. The TPV compositions include either COC or PP/COC blends in the continuous phase together with dynamically cured, dispersed, and cross-linked EPDM rubber particles. The TPV compositions include a blend of COCs with different glass transition temperatures. The cross-linked EPDM rubber particles provide elasticity, the semi-crystalline PP provides processability and strength, and the amorphous COC modifies thermal and mechanical behavior of the thermoplastic matrix.

The inventive TPV compositions demonstrate loss tangent (tan δ) peaks in the temperature window of about −20 to about 90° C., indicating peak vibration damping performance in this temperature window. The inventive TPV compositions also demonstrate a compression set between about 15% and about 50% at 70° C. after 22 hr of compression, or between about 15% and about 45%, or between about 20% and about 45%, which is up to a 40% improvement over conventional PP/EPDM TPVs without COCs.

The TPV compositions described herein have potential applications as new vibration damping materials. Vibration damping can be characterized by the loss tangent (tan δ). Higher tan δ values indicate increasing vibration dampening, i.e. increased energy absorption and dispersal throughout the material. Loss tangent of a material is highly dependent on temperature and vibrational frequency, and the loss tangent of the TPV compositions exhibits at least one peak within a certain temperature window. TPV compositions useful for alternative vehicle applications require vibration damping in the range of about −20 to about 90° C., or more particularly the range of about 0 to about 60° C.

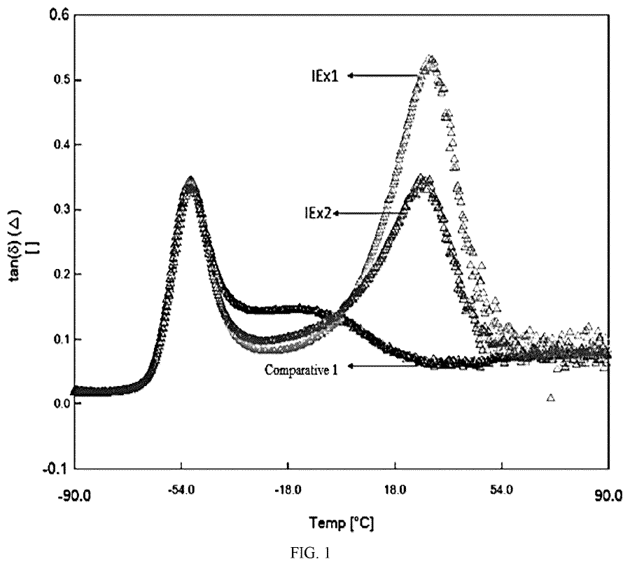

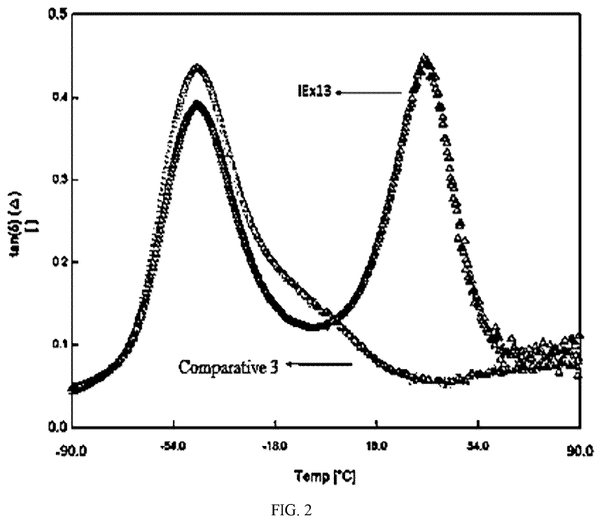

The TPV compositions demonstrate improved vibration damping over conventional TPV compositions without COCs. FIGS. 1 and 2 show vibration damping of inventive TPV compositions with COCs compared to conventional TPVs without COCs, wherein IEx1, IEx2, and IEx13 are inventive TPV compositions with COCs and Comparative 1 and Comparative 3 are conventional TPVs without COCs, with compositions and preparation described in Examples 1 and 2 below. As shown in FIGS. 1 and 2, the TPV compositions demonstrate peak loss tangent values at temperature windows approximately between about −20 and about 60° C. By contrast, the Comparatives 1 and 3 (with no COCs) demonstrated peak values well below 0° C. The TPV compositions described herein also have a vibration damping peak occurring between about −20 and about 90° C., between about −10 and about 55° C., or between about 0 and about 50° C.

Also shown in FIGS. 1 and 2, the inventive TPV compositions demonstrate higher peak loss tangent values than the Comparatives 1 and 3. The disclosed TPV compositions exhibit a vibration damping peak with a peak value between about 0.1 and about 2.0 in the temperature window between −20° C. to 90° C., whereas Comparatives 1 and 3 demonstrated peak values below 0.1 in the same temperature window. The TPV compositions described herein can have a vibration damping peak between about 0.1 and about 2.5, between about 0.1 and about 2.0, between about 0.1 and about 1.5, between about 0.2 and about 1.0, or between about 0.4 and about 0.9.

The TPV composition disclosed herein can demonstrate up to 40% improvement of compression set compared to a conventional PP/EPDM TPV without COCs.

The compression set is affected by interactions of the phases within the TPV compositions. The rubber phase is a cross-linked, separated or dispersed phase and the plastic phase is the continuous phase. Thus, the thermal and elastic behavior of the TPV compositions is mainly decided by the thermal behavior of the continuous plastic phase. For TPV compositions containing rigid glassy COC in the continuous phase, rubber particles are confined in the COC matrix in its glassy state at working temperature, which can hardly recover after deformation, resulting in a high compression set. By contrast, COCs of moderate Tg that can be plasticized by the processing oil to achieve a broad loss tangent can be softened to their elastic state at working temperature, bringing a low compression set to the corresponding TPV compositions.

The TPV compositions described herein have a compression set of between about 15% and about 50% at 70° C., after 22 hr of compression, or between about 15% and about 45%, or between about 20% and about 45%. The thermoplastic vulcanizate compositions can have compression set of between about 15% and about 50% at 70° C. after 22 hr of compression, or between about 17% and about 49%, or between about 25% and about 35%, or less than about 42%.

The TPV compositions described herein have a hardness between about 15 and about 95 measured on a Shore A durometer hardness scale at 15 sec after indentation. The thermoplastic vulcanizate compositions can have a hardness between about 30 and about 87, between about 40 and about 87, or between about 50 and about 72.

Discussed below are thermoplastic vulcanizate compositions that include a thermoplastic matrix including a cyclic olefin copolymer and an oil. Particles that include an at least partially cross-linked rubber are dispersed in the thermoplastic matrix. With this composition, the thermoplastic vulcanizate composition has a vibration damping peak occurring between about −20° C. and about 90° C.

### Thermoplastic Matrix

The TPV compositions described herein comprise a thermoplastic matrix. The thermoplastic matrix can include a polymer that can flow above its melting temperature. Optionally, the major component of the thermoplastic matrix includes a polypropylene (such as a homopolymer, random copolymer, or impact copolymer, or combination thereof), or a polyethylene. The thermoplastic phase may also include an ethylene-based polymer (e.g., polyethylene) or a propylene-based polymer (e.g., polypropylene). The thermoplastic phase can further include a butene-1-based polymer.

The TPV compositions described herein comprise the thermoplastic matrix in an amount from about 20 to about 500 parts by weight per 100 parts rubber (about 20 to about 500 phr). The thermoplastic vulcanizate compositions can comprise the thermoplastic matrix in an amount from about 50 to about 450 phr, from about 100 to about 250 phr, or from about 150 to about 200 phr.

Propylene-based polymers suitable for the matrix include those solid, generally high-molecular weight plastic resins that primarily comprise units deriving from the polymerization of propylene. At least 75%, at least 90%, at least 95%, or at least 97% of the units of the propylene-based polymer derive from the polymerization of propylene. These polymers can include homopolymers of propylene. Homopolymer polypropylene can comprise linear chains and/or chains with long chain branching.

The propylene-based polymers may also include units deriving from the polymerization of ethylene and/or α-olefins such as 1-butene, 1-hexene, 1-octene, 2-methyl-1-propene, 3-methyl-1-pentene, 4-methyl-1-pentene, 5-methyl-1-hexene, and mixtures thereof. Specifically included are the reactor, impact, and random copolymers of propylene with ethylene or the higher α-olefins, described above, or with C10-C20 olefins.

The propylene-based polymer can include one or more of the following characteristics:
1) The propylene-based polymers may include semi-crystalline polymers. These polymers may be characterized by a crystallinity of at least 25 wt % or more (such as about 55 wt % or more, such as about 65 wt % or more, such as about 70 wt % or more). Crystallinity may be determined by dividing the heat of fusion (Hf) of a sample by the heat of fusion of a 100% crystalline polymer, which is assumed to be 209 joules/gram for polypropylene.
2) A Hf that is about 52.3 J/g or more (such as about 100 J/g or more, such as about 125 J/g or more, such as about 140 J/g or more).
3) A weight average molecular weight (Mw) that is between about 50,000 g/mol and about 2,000,000 g/mol (such as between about 100,000 g/mol and about 1,000,000 g/mol, such as between about 100,000 g/mol and about 600,000 g/mol or between about 400,000 g/mol and about 800,000 g/mol) as measured by GPC with polystyrene standards.
4) A number average molecular weight (Mn) that is between about 25,000 g/mol and about 1,000,000 g/mol (such as between about 50,000 g/mol and about 300,000 g/mol) as measured by GPC with polystyrene standards.
5) A g′ᵥᵢₛ that is 1 or less (such as 0.9 or less, such as 0.8 or less, such as 0.6 or less, such as 0.5 or less.
6) A melt mass flow rate (MFR) (ASTM D1238, 2.16 kg weight@230° C.) that is about 0.1 g/10 min or more (such as about 0.2 g/10 min or more, such as about 0.2 g/10 min or more). Alternately, the MFR is between about 0.1 g/10 min and about 50 g/10 min, such as between about 0.5 g/10 min and about 5 g/10 min, such as between about 0.5 g/10 min and about 3 g/10 min.
7) A melt temperature (Tm) that is from about 110° C. to about 170° C. (such as from about 140° C. to about 168° C., such as from about 160° C. to about 165° C.).
8) A glass transition temperature (Tg) that is from about −50° C. to about 10° C. (such as from about −30° C. to about 5° C., such as from about −20° C. to about 2° C.).
9) A crystallization temperature (Tc) that is about 75° C. or more (such as about 95° C. or more, such as about 100° C. or more, such as about 105° C. or more (such as between about 105° C. and about 130° C.).

The propylene-based polymers can include a homopolymer of a high-crystallinity isotactic or syndiotactic polypropylene. This polypropylene can have a density of from about 0.89 to about 0.91 g/ml, with the largely isotactic polypropylene having a density of from about 0.90 to about 0.91 g/ml. Also, high and ultra-high molecular weight polypropylene that has a fractional melt flow rate can be employed. Polypropylene resins may be characterized by a MFR (ASTM D-1238; 2.16 kg@230° C.) that is about 10 dg/min or less (such as about 1.0 dg/min or less, such as about 0.5 dg/min or less).

The polypropylene can include a homopolymer, random copolymer, or impact copolymer polypropylene or combination thereof. The polypropylene can be a high melt strength (HMS) long chain branched (LCB) homopolymer polypropylene.

The propylene-based polymers may be synthesized by using an appropriate polymerization technique known in the art such as the conventional Ziegler-Natta type polymerizations, and catalysis employing single-site organometallic catalysts including metallocene catalysts.

Examples of polypropylene useful for the thermoplastic matrix of the TPV compositions described herein include ExxonMobil™ pp 5341 (available from ExxonMobil™); Achieve™ pp 6282NE1 (available from ExxonMobil™); Achieve™ pp 6302E1; Waymax™ MFX6 (available from Japan Polypropylene Corp.™); Borealis Daploy™ WB140 (available from Borealis™ AG); and Braskem Ampleo™ 1025MA and Braskem Ampleo™ 1020GA (available from Braskem Ampleo™).

The thermoplastic matrix of the TPV compositions can also include ethylene-based polymers. Ethylene-based polymers include those solid, generally high-molecular weight plastic resins that primarily comprise units deriving from the polymerization of ethylene. At least 90%, at least 95%, or at least 99% of the units of the ethylene-based polymer derive from the polymerization of ethylene. These polymers can include homopolymers of ethylene.

The ethylene-based polymers may also include units deriving from the polymerization of α-olefins such as propylene, 1-butene, 1-hexene, 1-octene, 2-methyl-1-propene, 3-methyl-1-pentene, 4-methyl-1-pentene, 5-methyl-1-hexene, and mixtures thereof.

The ethylene-based polymer can include one or more of the following characteristics:
1) A melt index (MI) (ASTM D-1238, 2.16 kg@190° C.) that is from about 0.1 dg/min to about 1,000 dg/min (such as from about 1.0 dg/min to about 200 dg/min, such as from about 7.0 dg/min to about 20.0 dg/min).
2) A melt temperature (Tm) that is from about 140° C. to about 90° C. (such as from about 135° C. to about 125° C., such as from about 130° C. to about 120° C.).

The ethylene-based polymers may be synthesized by using an appropriate polymerization technique known in the art such as the conventional Ziegler-Natta type polymerizations, and catalysis employing single-site organometallic catalysts including metallocene catalysts. Ethylene-based polymers are commercially available. For example, polyethylene is commercially available under the tradename ExxonMobil™ Polyethylene (ExxonMobil™). Ethylene-based copolymers are commercially available under the tradename ExxonMobil™ Polyethylene (ExxonMobil™), which include metallocene produced linear low density polyethylene including Exceed™, Enable™, and Exceed™ XP.

The polyethylene can include a low density, linear low density, or high density polyethylene. The polyethylene can be a high melt strength (HMS) long chain branched (LCB) homopolymer polyethylene.

The thermoplastic matrix of the TPV compositions can also include butene-1-based polymers. Butene-1-based polymers include those solid, generally high-molecular weight isotactic butene-1 resins that primarily comprise units deriving from the polymerization of butene-1.

The butene-1-based polymers can include isotactic poly(butene-1-homopolymers. They can include copolymers copolymerized with comonomer such as ethylene, propylene, 1-butene, 1-hexane, 1-octene, 4-methyl-1-pentene, 2-methyl-1-propene, 3-methyl-1-pentene, 4-methyl-1-pentene, 5-methyl-hexene, and mixtures of two or more thereof.

The butene-1-based polymer can include one or more of the following characteristics:
1) At least 90 wt % or more of the units of the butene-1-based polymer derive from the polymerization of butene-1 (such as about 95 wt % or more, such as about 98 wt % or more, such as about 99 wt % or more). These polymers can include homopolymers of butene-1.
2) A melt index (MI) (ASTM D-1238, 2.16 kg@190° C.) that is about 0.1 dg/min to 800 dg/min (such as from about 0.3 dg/min to about 200 dg/min, such as from about 0.3 dg/min to about 4.0 dg/min), or an MI of about 500 dg/min or less (such as about 100 dg/min or less, such as about 10 dg/min or less, such as about 5 dg/min or less).
3) A melt temperature (Tm) that is from about 130° C. to about 110° C. (such as from about 125° C. to about 115° C., such as from about 125° C. to about 120° C.).
4) A density, as determined according to ASTM D 792, that is from about 0.897 g/ml to about 0.920 g/ml, such as from about 0.910 g/ml to about 0.920 g/ml, or a density that is about 0.910 g/ml or more, such as 0.915 g/ml or more, such as about 0.917 g/ml or more.

The butene-1-based polymers may be synthesized by using an appropriate polymerization technique known in the art such as the conventional Ziegler-Natta type polymerizations, and catalysis employing single-site organometallic catalysts including metallocene catalysts. Butene-1-based polymers are commercially available. For example, isotactic poly(l-butene) is commercially available under the tradename Polybutene Resins™ or PB™ (Basell™).

When incorporated into TPV compositions, amorphous cyclic olefin copolymers (COCs) form a thermoplastic matrix that is elastic at working temperatures. The thermoplastic matrix can comprise COCs alone or can be a combination of semi-crystalline polyolefins (such as PP) and COCs. The thermoplastic matrix can further comprise a blend of COCs with different glass transition temperatures. Including semi-crystalline PP and amorphous COC in the thermoplastic matrix provides a balance of elasticity and high temperature performance to the TPV compositions as measured by compression set and dynamic mechanical properties at high temperatures.

### Amorphous Cyclic Olefin Polymers and Copolymers

The synergy of the semi-crystalline phase, rigid amorphous phase, and soft amorphous phase in the thermoplastic matrix can form an elastomeric structure with a hard segment and a soft segment. In the TPV composition, the cross-linked EPDM rubber provides elasticity, the semi-crystalline PP provides processability and strength, and the mobility of the amorphous COC phase can be tuned by the microstructure and amount of plasticizer in the TPV composition to modify the behavior of the continuous phase.

COCs can be incorporated into the thermoplastic matrix to tune properties of the TPV compositions. For example, COCs with a Tg around ambient range (typically room temperature to 200° C.) become softened and stay in a highly elastic state under working temperature. The differing thermal behavior compared to rigid semi-crystalline PP makes COC work as a “soft filler” to toughen the PP matrix and to localize crystalline PP under heating and stress, achieving a very low compression set compared to a traditional PP/EPDM TPV composition. Additionally, the Tg of COC being around room temperature could give the TPV composition better damping properties while keeping superior elasticity.

TPV compositions containing COCs of low to moderate Tg (typically Tg<100° C.) show better stretchability and lower compression set due to the more flexible polymer chains and better dispersion of EPDM rubber. Incorporating a COC with Tg around ambient temperature into the TPV composition can also provide a broad high tan δ around working temperature, enhancing the vibration damping of the TPV composition while maintaining a superior elasticity. The breadth and position of the loss tangent peak can be further optimized by choosing or combining different COCs and/or by adding plasticizer to shift the Tg of the COC.

For ethylene-norbornene COCs, the glass transition temperature changes with norbornene incorporation into the backbone, and thus the chain flexibility and rigidity of the COC (and thus the TPV composition) can be tuned by the norbornene content. Due to the steric hindrance of the rigid cyclic unit, the COC molecule is difficult to align and crystallize. Thus most COCs are amorphous polymers. There are several mechanisms by which norbornene can incorporate into the polyethylene backbone, meaning COCs can form a wide range of microstructures and correspondingly can have unique properties with a combination of a soft amorphous segment (isolated norbornene units) and a rigid amorphous segment (more alternating and blocky norbornene units), together with a potential semi-crystallized polyethylene segment.

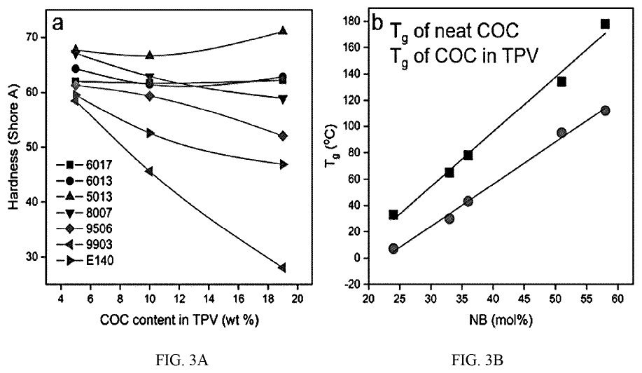

FIGS. 3A and 3B demonstrate the capability of COCs to tune hardness and glass transition temperature of the TPV compositions, and particularly the capability of ethylene-norbornene COCs to do so. FIG. 3A shows hardness as a function of COC content for TPV compositions comprising a variety of TOPAS™ COCs. FIG. 3B shows two curve fittings, each with five data points. The top curve fitting shows the Tg of neat COCs not incorporated into TPV compositions. The bottom curve fitting shows the Tg of TPV compositions with incorporated COCs. From left to right, the data points represent the following COCs: TOPAS™ 9903, 9506, 8007, 5013, and 6017, respectively. Additionally, not shown is a thermoplastic vulcanizate composition comprising TOPAS™ E-140, which had a Tg of about 6° C.

FIG. 3A demonstrates the capability of COCs to tune the hardness of the TPV compositions. As shown in FIG. 3A, thermoplastic vulcanizate compositions with TOPAS™ 6017/6013/5013 demonstrated no significant change or slightly increasing Shore A hardness with increasing cyclic olefin copolymer content. This could be explained by the fact that the Tg of these neat cyclic olefin copolymers is much higher than room temperature. For TOPAS™ 8007/9506/9903/E140, the hardness of the corresponding thermoplastic vulcanizate compositions decreased observably with increasing cyclic olefin copolymer content, which indicates these cyclic olefin copolymers were in a softened state under ambient conditions, making the thermoplastic vulcanize compositions feel softer.

FIG. 3B demonstrates the capability of COCs to tune the Tg of the TPV compositions. As shown in FIG. 3B, the glass transition temperature of the TPV compositions with COCs is lower than that of neat COCs (which do not have plasticizing oil). The amorphous COC is plasticized by the oil in the EPDM rubber, lowering the Tg. The more COC incorporated into the TPV composition, the more significant Tg shift can be observed due to higher distribution of oil into the plastic phase. Thus, the Tg of the TPV composition could be tuned by COC content, COC selection, or COC plasticization (adding plasticizer in the formulation).

FIG. 3B also shows that the glass transition temperature of the cyclic olefin copolymer increased with norbornene incorporation. The Tg of the inventive TPV compositions ranged from about 0 to about 120° C., whereas the Tg of the cyclic olefin copolymers in a neat condition ranged from about 30 to about 180° C. and was consistently higher than that of the TPV compositions.

The cyclic olefin copolymer of the TPV compositions described herein has a glass transition temperature (Tg) of about 30° C. to about 200° C. in a neat condition. The cyclic olefin copolymer can have a glass transition temperature in a neat condition of about 30° C. to about 100° C., from about 30° C. to about 90° C., from about 35° C. to about 70° C., from about 40° C. to about 60° C., or greater than about 30° C.

The thermoplastic matrix of the TPV compositions comprises from about 1 wt % to about 100 wt % the cyclic olefin copolymer and up to 99 wt % a semi-crystalline polyolefin. The thermoplastic matrix can comprise the cyclic olefin copolymer in an amount from about 10 wt % to about 90 wt %, from about 20 wt % to about 80 wt %, from about 30 wt % to about 70 wt %, or from about 40 wt % to about 60 wt %. The thermoplastic matrix can comprise the semi-crystalline polyolefin in an amount from about 0 wt % to about 99 wt %, from about 10 wt % to about 90 wt %, from about 20 wt % to about 80 wt %, from about 30 wt % to about 70 wt %, from about 40 wt % to about 60 wt, or up to 99 wt %.

Cycloolefins are mono- or polyunsaturated polycyclic ring systems, such as cycloalkenes, bicycloalkenes, tricycloalkenes or tetracycloalkenes. The ring systems can be monosubstituted or polysubstituted. Suitable cyclic olefins for use in the COC include norbornene, tricyclodecene, dicyclopentadiene, tetracyclododecene, hexacycloheptadecene, tricycloundecene, pentacyclohexadecene, ethylidene norbornene (ENB), vinyl norbornene (VNB), norbornadiene, alkylnorbornenes, cyclopentene, cyclopropene, cyclobutene, cyclohexene, cyclopentadiene (CP), cyclohexadiene, cyclooctatriene, indene, any Diels-Alder adduct of cyclopentadiene and an acyclic olefin, cyclic olefin, or diene; and any Diels-Alder adduct of butadiene and an acyclic olefin, cyclic olefin, or diene; vinylcyclohexene (VCH); vinylcyclobutane (VCB); alkyl derivatives of cyclic olefins; and aromatic derivatives of cyclic olefins. The cyclic olefin monomers are incorporated into either COC or COP materials useful in connection with the present TPV compositions and can be prepared with the aid of transition-metal catalysts, e.g. metallocenes.

Particularly preferred cyclic olefin copolymers include cyclic olefin monomers copolymerized with acyclic olefin monomers. Suitable acyclic olefins for use in the COC include alpha olefins (1-alkenes), isobutene, 2-butene, and vinylaromatics. Examples of such acyclic olefins include ethylene, propylene, 1-butene, isobutene, 2-butene, 1-pentene, 1-hexene, 1-heptene, 1-octene, 1-nonene, 1-decene, styrene, p-methylstyrene, p-t-butylstyrene, p-phenylstryene, 3-methyl-1-pentene, vinylcyclohexane, 4-methyl-1-pentene, alkyl derivatives of acyclic olefins, aromatic derivatives of acyclic olefins, and combinations thereof.

The cyclic olefin copolymer of the TPV compositions described herein can comprise an ethylene-norbornene copolymer comprising from about 40 wt % to about 90 wt % norbornene. The cyclic olefin copolymer can comprise an ethylene-norbornene copolymer comprising from about 50 wt % to about 80 wt % norbornene, from about 60 wt % to about 70 wt % norbornene, or from about 66 wt % to about 68 wt % norbornene. Alternatively, preferred COCs contain about 10 to about 80 mol % of the cyclic olefin monomer moiety and about 20 to about 90 wt % of the acyclic olefin moiety (such as ethylene). Cycloolefin copolymers which are suitable for the purposes of the present TPV compositions typically have a mean molecular weight Mw in the range from more than about 200 g/mol to about 400,000 g/mol. COCs can be characterized by their glass transition temperature, Tg, which is generally in the range from about 20° C. to about 200° C., preferably in the range from about 30° C. to about 130° C. The cyclic olefin polymer can be a copolymer such as TOPAS® 8007F-04, which includes approximately 36 mol % norbornene and the balance ethylene. TOPAS® 8007F-04 has a glass transition temperature of about 78° C. Other preferred COCs include melt blends of partially crystalline cycloolefin elastomer and amorphous COC materials with low glass transition temperatures. One preferred material for blending with partially crystalline cycloolefin elastomer is TOPAS® 9506F-04 which has a Tg of about 68° C. Still another preferred amorphous COC for blending with partially crystalline cycloolefin elastomer is TOPAS® 9903D-10 which has a glass transition temperature of about 33° C.

Additionally, the COCs can contain a suitable dienes such as 1,4-hexadiene; 1,5-hexadiene; 1,5-heptadiene; 1,6-heptadiene; 1,6-octadiene; 1,7-octadiene; 1,9-decadiene; butadiene; 1,3-pentadiene; isoprene, 1,3-hexadiene; 1,4-pentadiene; p-divinylbenzene: alkyl derivatives of dienes; and aromatic derivatives of dienes.

Taking these elements together, suitable COCs for use in the TPV composition include ethylene-norbornene copolymers; ethylene-dicyclopentadiene copolymers; ethylene-norbornene-dicyclopentadiene terpolymers: ethylene-norbornene-ethylidene norbornene terpolymers; ethylene-norbornene-vinylnorbornene terpolymers; ethylene-norbornene-1,7-octadiene terpolymers; ethylene-cyclopentene copolymers; ethylene-indene copolymers; ethylene-tetracyclododecene copolymers; ethylene norbornene-vinylcyclohexene terpolymers; ethylene norbornene-7-methyl-1,6-octadiene terpolymers; propylene-norbornene copolymers; propylene-dicyclopentadiene copolymers; ethylene-norbornene-styrene terpolymers; ethylene-norbornene-p-methylstyrene terpolymers; functionalized ethylene-dicyclopentadiene copolymers; functionalized propylene-dicyclopentadiene copolymers; functionalized ethylene-norbornene-diene copolymers; maleic anhydride grafted cyclic olefin copolymers; silane-grafted cyclic olefin copolymers; hydrogenated ethylene dicyclopentadiene copolymers; epoxidized ethylene-dicyclopentadiene copolymers; epoxidized ethylene-norbornene-dicyclopentadiene terpolymers; grafted cyclic olefin copolymers; short chain branched cyclic olefin copolymers; long chain branched cyclic olefin copolymers; and crosslinked cyclic olefin copolymers.

The COC can be produced by copolymerizing at least one cyclic olefin with at least one acyclic olefin and optionally one or more dienes. The total of amount of all the cyclic olefins in the COC is from about 20 to about 99 weight % of the copolymer. Additionally, the residual double bonds in cyclic olefin copolymers may not have reacted or may have been hydrogenated, cross-linked, or functionalized. Cyclic olefin copolymers may also have been grafted using free radical addition reactions or in-reactor copolymerizations. The COCs may be block copolymers made using chain shuttling agents. The COCs can also be made using Vanadium, Ziegler-Natta, and metallocene catalysts. Norbornene is made from the Diels-Alder addition of cyclopentadiene and ethylene.

Cycloolefin copolymers which are suitable for the purposes of the present TPV compositions typically have a mean molecular weight Mw in the range from more than 200 g/mol to 400,000 g/mol. COCs can be characterized by their glass transition temperature, Tg, which is generally in the range from about 20° C. to about 200° C., preferably in the range from about 30° C. to about 130° C. Ethylene-norbornene copolymers can be purchased from Topas Advanced Polymers™ and Mitsui Chemicals™. Ethylene/norbornene copolymers made with metallocene catalysts are available commercially from Topas Advanced Polymers™ GmbH, as TOPAS™ copolymers. The cyclic olefin polymer can be a copolymer such as TOPAS™ 8007F-04 which includes approximately 36 mol % norbornene and the balance ethylene. TOPAS™ 8007F-04 has a glass transition temperature of about 78° C. The COC can be TOPAS™ 9903D-10 which has a glass transition temperature of about 33° C. The COC can be TOPAS™ 9506F-04 which has a Tg of about 68° C. The cyclic olefin polymer can be TOPAS™ 6015 or TOPAS® 6017 which each have a Tg of about 160° C. and about 180° C., respectively. The TPV compositions can further include melt blends of amorphous COC materials with different glass transition temperatures.

### Cyclic Olefin Copolymer Elastomers

The thermoplastic matrix of the TPV composition can contain COC elastomers. Such COC elastomers are elastomeric cyclic olefin copolymers available from TOPAS™ Advanced Polymers under the commercial name E-140. E-140 polymer features two glass transition temperatures, one of about 6° C. and another glass transition temperature below −90° C. E-140 polymer has a crystalline melting point of about 84° C. Unlike completely amorphous TOPAS™ COC grades, COC elastomers typically contain between about 10 and about 30 percent crystallinity by weight. E-140 has a density of 940 kg/m³ (ISO 1183), a melt volume rate (MVR) of 3 cm₃/10 min (ISO 1133@2.16 kg/190° C.), a melt volume rate (MVR) of 12 cm₃/10 min (ISO 1133@2.16 kg/260° C.), and a Shore A Hardness of about 89. Thermal properties of E-140 include a glass transition temperature of about 6° C. DSC (10° C./min) and a melt temperature of about 84° C. E-140 has multiple glass transitions (Tg); one occurs at less than −90° C. and the other occurs in the range from −10° C. to 15° C.

For an E-140 copolymer elastomer having a norbornene content of about 8-9 mol %, it has been observed that the partially crystalline COC elastomer exhibits a rubbery modulus plateau between about 10-20° C. and 80-90° C. The partially crystalline ethylene/norbornene copolymer elastomer may have a norbornene content of from 1-20 mol %.

COC elastomers suitable for the TPV compositions have a very low norbornene-ethylene-norbornene triad content and have 2 distinct blocky portions. One set of polymer blocks contains a relatively high norbornene content and remain amorphous, while another set of polymer block copolymers is thought to have a relatively low norbornene content and can crystallize partially.

Generally, suitable partially crystalline elastomers of norbornene and ethylene include from 0.1 mol % to 20 mol % norbornene, have at least one glass transition temperature of less than 30° C., a crystalline melting temperature of less than 125° C., and 40% or less crystallinity by weight. Particularly preferred elastomers exhibit a crystalline melting temperature of less than 90° C. and more than 60° C.

### Cross-Linked Rubber

As described above, the TPV compositions comprise particles comprising an at least partially cross-linked rubber that are dispersed in the thermoplastic matrix. The cross-linked rubber particles include those polymers that have been cross-linked by a phenolic resin or a hydrosilylation curative (e.g., silane-containing curative), a peroxide with a coagent, a moisture cure via silane grafting, metal oxides/Phenolic resin, or an azide. Reference to a rubber may include mixtures of more than one rubber. Non-limiting examples of rubbers include olefinic elastomeric terpolymers, and mixtures thereof. Olefinic elastomeric terpolymers include ethylene-based elastomers such as ethylene-propylene-non-conjugated diene rubbers. Other non-limiting examples of rubbers can include olefinic elastomeric terpolymers, butyl rubbers (such as isobutylene-isoprene rubber (IIR), brominated isobutylene-isoprene rubber (BIIR), isobutylene paramethylstyrene rubber (BIMSM), halogenated copolymers of a C₄ to C₇ isomonoolefin and a paraalkylstyrene), and combinations and mixtures thereof.

### 1. Ethylene-Propylene Rubber

The term ethylene-propylene rubber refers to rubbery terpolymers polymerized from ethylene, at least one other α-olefin monomer, and at least one diene monomer (for example, an ethylene-propylene-diene terpolymer or an EPDM terpolymer). The α-olefin monomer can include propylene, 1-butene, 1-hexene, 4-methyl-1-pentene, 1-octene, 1-decene, or a combination thereof. The α-olefins can include propylene, 1-hexene, 1-octene or a combination thereof. The diene monomers can include 5-ethylidene-2-norbornene (ENB); 5-vinyl-2-norbornene (VNB); divinylbenzene; 1,4-hexadiene; 5-methylene-2-norbornene; 1,6-octadiene; 5-methyl-1,4-hexadiene; 3,7-dimethyl-1,6-octadiene; 1,3-cyclopentadiene; 1,4-cyclohexadiene; dicyclopentadiene; or a combination thereof. Polymers prepared from ethylene, α-olefin monomer, and diene monomer can be referred to as a terpolymer or even a tetrapolymer in the event that multiple α-olefin monomers or diene monomers are used.

Where the diene monomer includes 5-ethylidene-2-norbornene (ENB) or 5-vinyl-2-norbornene (VNB), the ethylene-propylene rubber can include at least about 1 wt % of diene monomer, such as at least about 3 wt %, such as at least about 4 wt %, such as at least about 5 wt %, such as at least about 10 wt %, based on the total weight of an ethylene-propylene rubber. Where the diene includes ENB or VNB, the ethylene-propylene rubber can include from about 1 wt % to about 15 wt % of diene monomer, such as from about 3 wt % to about 15 wt %, such as from about 5 wt % to about 12 wt %, such as from about 7 wt % to about 11 wt %, based on the total weight of the ethylene-propylene rubber.

The ethylene-propylene rubber can include one or more of the following:
1) An ethylene-derived content that can be from about 10 wt % to about 99.9 wt %, such as from about 10 wt % to about 90 wt %, such as from about 12 wt % to about 90 wt %, such as from about 15 wt % to about 90 wt %, such as from about 20 wt % to about 80 wt %, such as from about 40 wt % to about 70 wt %, such as from about 45 wt % to about 65 wt %, based on the total weight of the ethylene-propylene rubber. The ethylene-derived content can be from about 40 wt % to about 85 wt %, such as from about 40 wt % to about 85 wt % based on the total weight of the ethylene-propylene rubber.
2) A diene-derived content that can be from about 0.1 to about to about 15 wt %, such as from about 0.1 wt % to about 5 wt %, such as from about 0.2 wt % to about 10 wt %, such as from about 2 wt % to about 8 wt %, or from about 4 wt % to about 12 wt %, such as from about 4 wt % to about 9 wt % based on the total weight of the ethylene-propylene rubber. The diene-derived content can be from about 3 wt % to about 15 wt % based on the total weight of the ethylene-propylene rubber.
3) The balance of the ethylene-propylene rubber can be α-olefin-derived content, e.g., C2 to C40, such as C3 to C20, such as C3 to C10 olefins, such as propylene.
4) A weight average molecular weight (Mw) that can be about 100,000 g/mol or more, such as about 200,000 g/mol or more, such as about 400,000 g/mol or more, such as about 600,000 g/mol or more. The Mw can be about 1,200,000 g/mol or less, such as about 1,000,000 g/mol or less, such as about 900,000 g/mol or less, such as about 800,000 g/mol or less. The Mw can be from about 400,000 g/mol to about 3,000,000 g/mol, such as from about 400,000 g/mol to about 2,000,000, such as from about 500,000 g/mol to about 1,500,000 g/mol, such as from about 600,000 g/mol to about 1,200,000 g/mol, such as from about 600,000 g/mol to about 1,000,000 g/mol. Mw is measured according to GPC with polystyrene standards.
5) A number average molecular weight (Mn) that can be about 20,000 g/mol or more (such as about 60,000 g/mol or more, such as about 100,000 g/mol or more, such as about 150,000 g/mol or more. The Mn can be less than about 500,000 g/mol, such as about 400,000 g/mol or less, such as about 300,000 g/mol or less, such as about 250,000 g/mol or less. Mn is measured according to GPC with polystyrene standards.
6) A Z-average molecular weight (Mz) that can be from about 10,000 g/mol to about 7,000,000 g/mol, such as from about 50,000 g/mol to about 3,000,000 g/mol, such as from about 70,000 g/mol to about 2,000,000 g/mol, such as from about 75,000 g/mol to about 1,500,000 g/mol, such as from about 80,000 g/mol to about 700,000 g/mol, such as from about 100,000 g/mol to about 500,000 g/mol. Mz is measured according to GPC with polystyrene standards.
7) A polydispersity index (Mw/Mn; PDI) that can be from about 1 to about 10, such as from about 1 to about 5, such as from about 1 to about 4, such as from about 2 to about 4 or from about 1 to about 3, such as from about 1.8 to about 3 or from about 1 to about 2, or from about 1 to about 2.5, as measured by GPC with polystyrene standards.
8) A dry Mooney viscosity (ML (1+4) at 125° C.) per ASTM D-1646, that can be from about 10 MU to about 500 MU or from about 50 MU to about 450 MU. The Mooney viscosity can be about 250 MU or more, such as 350 MU or more, such as 450 MU or less.
9) A glass transition temperature (Tg), as determined by Differential Scanning calorimetry (DSC) according to ASTM E 1356, that can be about −20° C. or less, such as about −30° C. or less, such as about −50° C. or less. The Tg can be from about −20° C. to about −60° C.

The ethylene-propylene rubber can be manufactured or synthesized by using a variety of techniques. For example, these terpolymers can be synthesized by employing solution, slurry, or gas phase polymerization techniques or a combination thereof that employ various catalyst systems including Ziegler-Natta systems including vanadium catalysts and take place in various phases such as solution, slurry, or gas phase. Example catalysts can include single-site catalysts including constrained geometry catalysts involving Group IV-VI metallocenes. The EPDMs can be produced via a conventional Zeigler-Natta catalyst using a slurry process, especially those including Vanadium compounds, as well as metallocene catalysts. Other catalysts systems such as the Brookhart catalyst system can also be employed. Optionally, such EPDMs can be prepared using the above catalyst systems in a solution process.

Some elastomeric terpolymers are commercially available under the tradenames Vistalon™ (ExxonMobil Chemical Co.™; Houston, Tex.), Keltan™ (Arlanxeo Performance Elastomers™; Orange, TX.), Nordel™ IP (Dow™), NORDEL MG™ (Dow™), Royalene™ (Lion Elastomers™), KEP™ (Kumho Polychem™), and Suprene™ (SK Global Chemical™). Specific examples include Vistalon™ 3666, Vistalon™ 1696, Vistalon™ 9600, Keltan™ 9950C, Keltan™ 8550C, KEP™ 8512, KEP™ 9590, Keltan™ 5469 Q, Keltan™ 4969 Q, Keltan™ 5469 C, Keltan™ 4869 C, Royalene™ 694, Royalene™ 677, Suprene™ 512F, Nordel™ 6555, Nordel™ 4571XFM, Royalene™ 515.

The ethylene propylene rubber can be obtained in an oil extended form, with about a 50 phr to about 200 phr process oil, such as about 75 phr to about 120 phr process oil on the basis of 100 phr of rubber.

### 2. Butyl Rubber

Butyl rubber can include copolymers and terpolymers of isobutylene and at least one other comonomer. Useful comonomers can include isoprene, divinyl aromatic monomers, alkyl substituted vinyl aromatic monomers, and mixtures thereof. Example divinyl aromatic monomers can include vinylstyrene. Example alkyl substituted vinyl aromatic monomers can include a-methylstyrene and paramethylstyrene. These copolymers and terpolymers can be halogenated butyl rubbers (also known as halobutyl rubbers) such as in the case of chlorinated butyl rubber and brominated butyl rubber. These halogenated polymers can derive from monomer such as parabromomethylstyrene.

Butyl rubber can include copolymers of isobutylene and isoprene, and copolymers of isobutylene and paramethyl styrene, terpolymers of isobutylene, isoprene, and vinylstyrene, branched butyl rubber, and brominated copolymers of isobutene and paramethylstyrene (yielding copolymers with parabromomethylstyrenyl mer units). These copolymers and terpolymers can be halogenated. Example butyl rubbers can include isobutylene-isoprene rubber (IIR), brominated isobutylene-isoprene rubber (BIIR), chlorinated isobutylene-isoprene rubber (CIIR), isobutylene paramethyl styrene rubber (BIMSM), halogenated copolymer of a C₄ to C₇ isomonoolefin and a paraalkylstyrene, or a combination thereof.

The butyl rubber can include one or more of the following characteristics:
1) Where butyl rubber includes the isobutylene-isoprene rubber, the rubber can include isoprene in an amount from about 0.5 wt % to about 30 wt %, such as from about 0.8 wt % to about 5 wt %, based on the entire weight of the rubber with the remainder being isobutylene.
2) Where butyl rubber includes isobutylene-paramethylstyrene rubber, the rubber can include paramethylstyrene in an amount from about 0.5 wt % to about 25 wt %, such as from about 2 wt % to about 20 wt %, based on the entire weight of the rubber with the remainder being isobutylene.
3) Where the isobutylene-paramethylstyrene rubbers are halogenated, such as with bromine and/or chlorine, these halogenated rubbers can have a percent by weight halogenation of from about 0 wt % to about 10 wt %, such as from about 0.3 wt % to about 7 wt %, based on the entire weight of the rubber with the remainder being isobutylene.
4) Where the isobutylene-isoprene rubbers are halogenated, such as with bromine and/or chlorine, these halogenated rubbers can have a percent by weight halogenation of from about 0 wt % to about 10 wt %, such as from about 0.3 wt % to about 7 wt %, based on the entire weight of the rubber with the remainder being isobutylene.
5) Where butyl rubber includes isobutylene-isoprene-divinylbenzene, the butyl rubber can include isobutylene in an amount from about 95 wt % to about 99 wt %, such as from about 96 wt % to about 98.5 wt %, based on the entire weight of the rubber, and isoprene from about 0.5 wt % to about 5 wt %, such as from about 0.8 wt % to about 2.5 wt %, based on the entire weight of the rubber, with the balance being divinylbenzene.
6) Where the butyl rubber includes halogenated butyl rubbers, the butyl rubber can include from about 0.1 wt % to about 10 wt % halogen, such as from about 0.3 wt % to about 7 wt %, such as from about 0.5 wt % to about 3 wt %, based on the entire weight of the rubber.
7) A weight average molecular weight (Mw) that can be about 100,000 g/mol or more, such as about 200,000 g/mol or more, such as about 400,000 g/mol or more, such as about 600,000 g/mol or more). The Mw can be about 1,200,000 g/mol or less, such as about 1,000,000 g/mol or less, such as about 900,000 g/mol or less, such as about 800,000 g/mol or less). The Mw can be from about 500,000 g/mol to about 3,000,000 g/mol, such as from about 500,000 g/mol to about 2,000,000, such as from about 500,000 g/mol to about 1,500,000 g/mol, such as from about 600,000 g/mol to about 1,200,000 g/mol, such as from about 600,000 g/mol to about 1,000,000 g/mol. Mw is measured according to GPC with polystyrene standards.

Butyl rubber can be obtained from a number of commercial sources as disclosed in the Rubber World Blue Book. For example, both halogenated and un-halogenated rubbers/copolymers of isobutylene and isoprene are available under the tradename Exxon Butyl™ (ExxonMobil Chemical Co.™), halogenated and un-halogenated copolymers of isobutylene and paramethylstyrene are available under the tradename EXXPRO™ (ExxonMobil Chemical Co.™), star branched butyl rubbers are available under the tradename STAR BRANCHED BUTYL™ (ExxonMobil Chemical Co.™), and copolymers having parabromomethylstyrenyl mer units are available under the tradename EXXPRO™ 3745 (ExxonMobil Chemical Co.™). Halogenated and non-halogenated terpolymers of isobutylene, isoprene, and divinylstyrene are available under the tradename Polysar Butyl™ (Lanxess™; Germany).

The rubber (e.g., ethylene-propylene rubber or butyl rubber) can be highly cured. The rubber can be partially or fully (completely) cured. The degree of cure can be measured by determining the amount of rubber that is extractable from the TPV composition by using cyclohexane or boiling xylene as an extractant. The rubber can have a degree of cure where not more than about 5.9 wt %, such as not more than about 5 wt %, such as not more than about 4 wt %, such as not more than about 3 wt % is extractable by cyclohexane at 23° C. The rubber can be cured to an extent where greater than about 94 wt %, such as greater than about 95 wt %, such as greater than about 96 wt %, such as greater than about 97 wt % by weight of the rubber is insoluble in cyclohexane at 23° C. Alternatively, the rubber can have a degree of cure such that the crosslink density can be at least about 4×10−5 moles per milliliter of rubber, such as at least about 7×10−5 moles per milliliter of rubber, such as at least about 10×10−5 moles per milliliter of rubber. See also “Crosslink Densities and Phase Morphologies in Dynamically Vulcanized TPEs,” by Ellul et al., RUBBER CHEMISTRY AND TECHNOLOGY, Vol. 68, pp. 573-584 (1995).

Despite the fact that the rubber can be partially or fully cured, the compositions of this disclosure can be processed and reprocessed by conventional plastic processing techniques such as extrusion, injection molding, blow molding, and compression molding. The rubber within these thermoplastic elastomers can be in the form of finely-divided and well-dispersed particles of vulcanized or cured rubber within a continuous thermoplastic phase or matrix. A co-continuous morphology or a phase inversion can be achieved. Where the cured rubber is in the form of finely-divided and well-dispersed particles within the thermoplastic medium, the rubber particles can have an average diameter that is about 50 μm or less (such as about 30 μm or less, such as about 10 μm or less, such as about 5 μm or less, such as about 1 μm or less). At least about 50% of the particles, such as about 60% of the particles, such as about 75% of the particles can have an average diameter of about 5 μm or less, such as about 2 μm or less, such as about 1 μm or less.

### Oil

The TPV compositions also include an oil, such as a mineral oil, a synthetic oil, or a combination thereof. These oils may also be referred to as plasticizers or extenders. Mineral oils may include aromatic, naphthenic, paraffinic, and isoparaffinic oils, synthetic oils, and combinations thereof. The mineral oils may be treated or untreated. Useful mineral oils can be obtained under the tradename SUNPAR™ (Sun Chemicals™). Others are available under the name PARALUX™ (Chevron™), and PARAMOUNT™ (Chevron™). Other oils that may be used include hydrocarbon oils and plasticizers, such as organic esters and synthetic plasticizers. Many additive oils are derived from petroleum fractions, and have particular ASTM designations depending on whether they fall into the class of paraffinic, naphthenic, or aromatic oils. Other types of additive oils include alpha olefinic synthetic oils, such as liquid polybutylene. Additive oils other than petroleum based oils can also be used, such as oils derived from coal tar and pine tar, as well as synthetic oils, e.g., polyolefin materials.

The oil included in the TPV compositions can be a base stock. According to the American Petroleum Institute™ (API) classifications, base stocks are categorized in five groups based on their saturated hydrocarbon content, sulfur level, and viscosity index (Table 3). Lube base stocks are typically produced in large scale from non-renewable petroleum sources. Group I, II, and III base stocks are all derived from crude oil via extensive processing, such as solvent extraction, solvent or catalytic dewaxing, and hydroisomerization, hydrocracking and isodewaxing, isodewaxing and hydrofinishing.

Group III base stocks can also be produced from synthetic hydrocarbon liquids obtained from natural gas, coal or other fossil resources, Group IV base stocks are polyalphaolefins (PAOs), and are produced by oligomerization of alpha olefins, such as 1-decene. Group V base stocks include all base stocks that do not belong to Groups I-IV, such as naphthenics, polyalkylene glycols (PAG), and esters.

TABLE 1
API Base Stock Classifications

| API Class- | Group | Group | Group | Group | Group |
|---|---|---|---|---|---|
| ification | I | II | III | IV | V |
| % Saturates | <90 | ≥90 | ≥90 | Polyalpha- | All others not |
| % S | >0.03 | ≤0.03 | ≤0.03 | olefins | belonging to |
| Viscosity | 80-120 | 80-120 | ≥120 | (PAOs) | Groups I-IV |
| Index (VI) | | | | | |

Synthetic oils include polymers and oligomers of butenes including isobutene, 1-butene, 2-butene, butadiene, and mixtures thereof. These oligomers can be characterized by a number average molecular weight (Mn) of from about 300 g/mol to about 9,000 g/mol, or from about 700 g/mol to about 1,300 g/mol. These oligomers include isobutenyl mer units. Exemplary synthetic oils include polyisobutylene, poly(isobutylene-co-butene), and mixtures thereof. Synthetic oils may include polylinear α-olefins, poly-branched α-olefins, hydrogenated polyalphaolefins, and mixtures thereof.

The synthetic oils can include synthetic polymers or copolymers having a viscosity of about 20 cp or more, such as about 100 cp or more, such as about 190 cp or more, where the viscosity is measured by a Brookfield viscometer according to ASTM D-4402 at 38° C. The viscosity of these oils can be about 4,000 cp or less, such as about 1,000 cp or less.

Useful synthetic oils can be commercially obtained under the tradenames Polybutene™ (Soltex™; Houston, Tex.), and Indopol™ (Ineos™). White synthetic oil is available under the tradename SPECTRASYN™ (ExxonMobil™), formerly SHF Fluids™ (Mobil™), Elevast™ (ExxonMobil™), and white oil produced from gas to liquid technology such as Risella™ X 415/420/430 (Shell™) or Primol™ (ExxonMobil™) series of white oils, e.g. Primol™ 352, Primol™ 382, Primol™ 542, or Marcol™ 82, Marcol™ 52, Drakeol® (Pencero™) series of white oils, e.g. Drakeol® 34 or combinations thereof. Oils described in U.S. Pat. No. 5,936,028 may also be employed.

The TPV compositions comprise the oil in an amount from about 30 to about 450 parts by weight per 100 parts rubber (about 100 to about 450 phr). The thermoplastic vulcanizate composition can comprise the oil in an amount from about 50 to about 450 phr, about 100 to about 350 phr, from about 150 to about 300 phr, or from about 150 to about 250 phr.

### Other Constituents

The TPV compositions may further include an optional polymeric processing additive. The processing additive may be a polymeric resin that has a very high melt flow index. These polymeric resins include both linear and branched polymers that have a melt flow rate that is about 500 dg/min or more, such as about 750 dg/min or more, such as about 1000 dg/min or more, such as about 1200 dg/min or more, such as about 1500 dg/min or more. Mixtures of various branched or various linear polymeric processing additives, as well as mixtures of both linear and branched polymeric processing additives, can be employed. Reference to polymeric processing additives can include both linear and branched additives unless otherwise specified. Linear polymeric processing additives include polypropylene homopolymers, and branched polymeric processing additives include diene-modified polypropylene polymers.

In addition to the rubber, thermoplastic resins, and optional processing additives, the thermoplastic vulcanizate compositions of the present disclosure may optionally include reinforcing and non-reinforcing fillers, compatibilizers, antioxidants, stabilizers, rubber processing oil, lubricants, antiblocking agents, anti-static agents, waxes, foaming agents, pigments, flame retardants, nucleating agents, and other processing aids known in the rubber compounding art. These additives can comprise up to about 50 weight percent of the total composition.

Fillers and extenders that can be utilized in the TPV compositions include conventional inorganics such as calcium carbonate, clays, silica, talc, titanium dioxide, carbon black, a nucleating agent, mica, wood flour, and the like, and blends thereof, as well as inorganic and organic nanoscopic fillers.

### Preparation of TPV Compositions

The cross-linked rubber can be cured or cross-linked by dynamic vulcanization. The term dynamic vulcanization refers to a vulcanization or curing process for a rubber contained in a blend with a thermoplastic resin, wherein the rubber is cross-linked or vulcanized via reaction under conditions of high shear at a temperature above the melting point of the thermoplastic. The rubber can be cured by employing a variety of curatives. Exemplary curatives include phenolic resin cure systems, metal oxide/resin cure systems, metal oxides, peroxide cure systems, and silicon-containing cure systems, such as hydrosilylation and silane grafting/moisture cure. Dynamic vulcanization can occur in the presence of the COC and semi-crystalline PP, or the COC and/or semi-crystalline PP can be added after dynamic vulcanization (i.e., post added), or both (i.e., some COC and semi-crystalline PP can be added prior to dynamic vulcanization and some COC and semi-crystalline PP can be added after dynamic vulcanization). The rubber can be simultaneously cross-linked and dispersed as fine particles within the thermoplastic matrix, although other morphologies may also exist.

Dynamic vulcanization can be effected by mixing the thermoplastic elastomer components at elevated temperature in conventional mixing equipment such as roll mills, stabilizers, Banbury mixers, Brabender mixers, continuous mixers, mixing extruders and the like. Methods employing low shear rates can also be used. Multiple-step processes can also be employed whereby ingredients, such as additional thermoplastic resin, can be added after dynamic vulcanization has been achieved. The skilled artisan will be able to readily determine a sufficient or effective amount of vulcanizing agent to be employed without undue calculation or experimentation.

The TPV compositions prepared according to the present disclosure can be dynamically vulcanized by a variety of methods including employing a phenolic resin cure system, a metal oxide/resin cure system, a metal oxide, a peroxide cure system, a maleimide cure system, a silicon-based cure system (including hydrosilylation cure system, a silane-based system such as a silane grafting followed by moisture cure), sulfur cure system, or a combination thereof.

Phenolic resin cure systems for dynamic vulcanization employ phenolic resin curatives which include resole resins, which can be made by the condensation of alkyl substituted phenols or unsubstituted phenols with aldehydes, such as formaldehydes, in an alkaline medium or by condensation of bi-functional phenoldialcohols. The alkyl substituents of the alkyl substituted phenols may contain between about 1 and about 10 carbon atoms, such as dimethylolphenols or phenolic resins, substituted in para-positions with alkyl groups containing between about 1 and about 10 carbon atoms. A blend of octylphenol-formaldehyde and nonylphenol-formaldehyde resins can be employed. The blend includes from about 25 wt % to about 40 wt % octylphenol-formaldehyde and from about 75 wt % to about 60 wt % nonylphenol-formaldehyde, such as from about 30 wt % to about 35 wt % octylphenol-formaldehyde and from about 70 wt % to about 65 wt % nonylphenol-formaldehyde. The blend can include about 33 wt % octylphenol-formaldehyde and about 67 wt % nonylphenol-formaldehyde resin, where each of the octylphenol-formaldehyde and nonylphenol-formaldehyde include methylol groups. This blend can be solubilized in paraffinic oil at about 30% solids without phase separation.

Suitable phenolic resins may be obtained under the tradenames SP-1044™, SP-1045™ (Schenectady International™; Schenectady, N.Y.), which may be referred to as alkylphenol-formaldehyde resins. An example of a phenolic resin curative includes that defined according to the general formula:

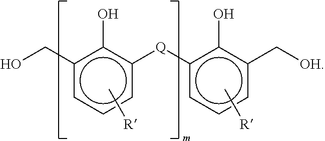

where Q is a divalent radical selected from the group consisting of —CH₂—,—CH₂—O—CH₂—; m is zero or a positive integer from 1 to 20 and R′ is an organic group. Q can be the divalent radical —CH₂—O—CH₂—, m is zero or a positive integer from 1 to 10, and R′ is an organic group having less than 20 carbon atoms. Optionally, m is zero or a positive integer from 1 to 10 and R′ is an organic radical having between 4 and 12 carbon atoms.

The phenolic resin can be used in combination with a halogen source, such as stannous chloride, and metal oxide or reducing compound such as zinc oxide. The phenolic resin may be employed in an amount from about 2 parts by weight to about 6 parts by weight, such as from about 3 parts by weight to about 5 parts by weight, such as from about 4 parts by weight to about 5 parts by weight per 100 parts by weight of rubber. A complementary amount of stannous chloride may include from about 0.5 parts by weight to about 2.0 parts by weight, such as from about 1.0 parts by weight to about 1.5 parts by weight, such as from about 1.2 parts by weight to about 1.3 parts by weight per 100 parts by weight of rubber. In conjunction therewith, from about 0.1 parts by weight to about 6.0 parts by weight, such as from about 1.0 parts by weight to about 5.0 parts by weight, such as from about 2.0 parts by weight to about 4.0 parts by weight of zinc oxide may be employed. The olefinic rubber employed with the phenolic curatives can include diene units deriving from 5-ethylidene-2-norbornene.

As described above, dynamic vulcanization of the TPV compositions can be performed with a peroxide cure system. Suitable peroxide curatives include organic peroxides. Examples of organic peroxides include di-tert-butyl peroxide, dicumyl peroxide, t-butylcumyl peroxide, a,a-bis(tert-butylperoxy) diisopropyl benzene, 2,5-dimethyl-2,5-di(t-butylperoxyjhexane (DBPH), 1,1-di(tert-butylperoxy)-3,3,5-trimethyl cyclohexane, n-butyl-4-4-bis(tert-butylperoxy) valerate, benzoyl peroxide, lauroyl peroxide, dilauroyl peroxide, 2,5-dimethyl-2,5-di(tert-butylperoxy) hexyne-3, and mixtures thereof. Also, diaryl peroxides, ketone peroxides, peroxydicarbonates, peroxyesters, dialkyl peroxides, hydroperoxides, peroxyketals and mixtures thereof may be used.

The peroxide curatives can be employed in conjunction with a coagent. Examples of coagents include triallylcyanurate, triallyl isocyanurate, triallyl phosphate, sulfur, N-phenyl bis-maleamide, zinc diacrylate, zinc dimethacrylate, divinyl benzene, 1,2-polybutadiene, trimethylol propane trimethacrylate, tetramethylene glycol diacrylate, trifunctional acrylic ester, dipentaerythritolpentacrylate, polyfunctional acrylate, retarded cyclohexane dimethanol diacrylate ester, polyfunctional methacrylates, acrylate and methacrylate metal salts, and oximes such as quinone dioxime. In order to maximize the efficiency of peroxide/coagent crosslinking the mixing and dynamic vulcanization may be carried out in a nitrogen atmosphere.

As described above, dynamic vulcanization of the TPV compositions can be performed with silicon-containing cure systems. Silicon-containing cure systems may include silicon hydride compounds having at least two Si—H groups. Silicon hydride compounds that are useful in practicing the present disclosure include methylhydrogenpolysiloxanes, methylhydrogendimethylsiloxane copolymers, alkylmethyl-co-methylhydrogenpolysiloxanes, bis(dimethylsilyl)alkanes, bis(dimethylsilyl)benzene, and mixtures thereof. Useful catalysts for hydrosilylation include transition metals of Group VIII. These metals include palladium, rhodium, and platinum, as well as complexes of these metals.

A silane-based system can also be used for dynamic vulcanization. The silane-containing compounds may be employed in an amount from about 0.5 parts by weight to about 5.0 parts by weight per 100 parts by weight of rubber (such as from about 1.0 parts by weight to about 4.0 parts by weight, such as from about 2.0 parts by weight to about 3.0 parts by weight). A complementary amount of catalyst may include from about 0.5 parts of metal to about 20.0 parts of metal per million parts by weight of the rubber (such as from about 1.0 parts of metal to about 5.0 parts of metal, such as from about 1.0 parts of metal to about 2.0 parts of metal). The olefinic rubber employed with the hydrosilylation curatives can include diene units deriving from 5-vinyl-2-norbornene.

The skilled artisan will be able to readily determine a sufficient or effective amount of vulcanizing agent to be employed without undue calculation or experimentation. For example, a phenolic resin can be employed in an amount of about 2 parts by weight to about 10 parts by weight per 100 parts by weight rubber (such as from about 3.5 parts by weight to about 7.5 parts by weight, such as from about 5 parts by weight to about 6 parts by weight). The phenolic resin can be employed in conjunction with stannous chloride and optionally zinc oxide. The stannous chloride can be employed in an amount from about 0.2 parts by weight to about 10 parts by weight per 100 parts by weight rubber (such as from about 0.3 parts by weight to about 5 parts by weight, such as from about 0.5 parts by weight to about 3 parts by weight). The zinc oxide can be employed in an amount from about 0.25 parts by weight to about 5 parts by weight per 100 parts by weight rubber (such as from about 0.5 parts by weight to about 3 parts by weight, such as from about 1 parts by weight to about 2 parts by weight).

Alternatively, a peroxide can be employed as the vulcanizing agent in an amount from about 1×10−5 moles to about 1×10−1 moles, such as from about 1×10−4 moles to about 9×10−2 moles, such as from about 1×10−2 moles to about 4×10−2 moles per 100 parts by weight rubber. The amount may also be expressed as a weight per 100 parts by weight rubber. This amount, however, may vary depending on the curative employed. For example, where 4,4-bis(tert-butyl peroxy) diisopropyl benzene is employed, the amount employed may include from about 0.5 parts by weight to about 12 parts by weight, such as from about 1 parts by weight to about 6 parts by weight per 100 parts by weight rubber. The skilled artisan will be able to readily determine a sufficient or effective amount of coagent that can be used with the peroxide without undue calculation or experimentation. The amount of coagent employed can be similar in terms of moles to the number of moles of curative employed. The amount of coagent may also be expressed as weight per 100 parts by weight rubber. For example, where the triallylcyanurate coagent is employed, the amount employed can include from about 0.25 phr to about 20 phr, such as from about 0.5 phr to about 10 phr, based on 100 parts by weight rubber.

The TPV compositions can comprise the reaction product formed by the reactive dynamic vulcanization curing processes described above. The curing processes described can be used alone or in combination with any suitable methods for dynamic vulcanization of thermoplastic vulcanizates. The TPV compositions can comprise a reaction product of dynamically curing a composition comprising a rubber, a cross-linker, a thermoplastic resin comprising a cyclic olefin copolymer, and an oil. The thermoplastic vulcanizate composition has a vibration damping peak occurring between about −20° C. and about 60° C.

### Applications

The TPV compositions described herein have potential applications in the components and housings of building materials, electrical and electronic appliances (e.g., personal computers, office automation equipment, audiovisual equipment, and cellular phones), optical instruments, precision instruments, toys, household/office electric appliances, and the like, particularly in those parts and molded materials that are utilized in the fields of the transit and transportation industries such as railway vehicles, automobiles, ships, and airplanes. Vibration damping and sound insulation properties are demanded for these applications, in addition to general material characteristics such as impact resistance, heat resistance, strength, and dimensional stability. The TPV compositions have further applications for damping vibrations produced from motor or tire pattern noises. More particularly, the thermoplastic vulcanizate compositions are useful in automotive vehicles with an electric motor, such as a hybrid vehicle, plug-in hybrid vehicle, fuel cell vehicle, or electric vehicle. The TPV compositions described herein can block a vibration-transmitting sound represented by a low-frequency range. In addition, the TPV compositions are also capable of effectively blocking sound in a high-frequency range of 1 to 6 kHz, which is sensitively detected by human ears.

### EXAMPLES

### General Procedures

The thermoplastic vulcanizate compositions of Examples 1 and 2 below were prepared using several common raw materials, which are listed below:
PP1: Commercial ExxonMobil™ low melt flow rate polypropylene homopolymer, with melt flow rate (230° C./2.16 kg) of 0.83 g/10 min (ASTM D1238) and density of 0.9 g/cm³.
PP2: Commercial Braskem™ polypropylene homopolymer, with Melt Flow Rate (230° C./2.16 kg) of 17 g/10 min (ASTM D1238).
COC1: TOPAS™ 8007. Commercial cyclic olefin copolymer with density of 1010 kg/m³ (ISO 1183), melt volume rate (190° C./2.16 kg) of 2 cm³/10 min (ISO1133), glass transition temperature of 78° C. (10° C./min, ISO11357-1,-2,-3), and nominal norbornene content of 66-68 wt %.
MB1: Carbon Black master batch with polypropylene homopolymer and carbon black pigment (41 wt %).
MB2: anhydrous SnCl₂ master batch with polypropylene homopolymer and SnCl₂ (45 wt %).
PO1: Group 2 paraffinic oil, Kinematic viscosity 108 cst@40° C. (available under the tradename Paramount™ 6001R from Chevron Philips™).
ZnO: Commercial ZnO cure moderator/acid scavenger available under the tradename Kadox™ 911.
RIO1: Phenolic resin in oil, mixture of octyl and isononyl phenolic resin with 30 wt % resin dispersed in group 2 paraffinic oil (70 wt %).
Clay: Calcined clay obtained under the tradename Icecap™ K Clay (available from Burgess™).

The thermoplastic vulcanizate compositions of Examples 1 and 2 below were also tested using several common procedures, which are detailed below:

Shore A Hardness was measured after 15 s and 1 s delay after indenting. The test was performed as per ASTM D2240.

Tensile properties (100% modulus, tensile strength, Ult. elongation) were measured as per ASTM D412, 500 mm/min.

Compression set was determined as per ASTM D395, Method B (25% compression, 22 hr@70° C.; 25% compression, 22 hr@23° C.)

Oil Swell was measured as per ASTM D471, 24 hrs, 121° C., expressed as wt % gain.

Specific gravity was measured at 23° C. as per ASTM D792.

LCR capillary viscosity was measured at 204° C. and a shear rate of 1200 l/s using a Laboratory Capillary Rheometer such as the Ceast “Smart Rheo” Rheometer™, with 30/1 L/D ratio capillary die having a round, 1 mm (0.040″) diameter orifice.

DMTA: tan δ properties were determined via dynamic mechanical temperature analysis in Torsion mode, using a heating rate of 2° C./min, frequency of 10 Hz, & amplitude of 0.15 to 1%. The dynamic viscoelastic properties were measured under these conditions using a viscoelasticity tester “ARES”. The ratio of the measured storage elastic modulus (G′) and loss elastic modulus (G″) was defined as the loss tangent tan δ. When the tan δ was plotted against temperature, a convex curve or peak was obtained. The temperature at the apex of the peak was defined as the glass transition temperature, and the maximum tan δ value at this temperature was determined. When two peaks were observed for the tan δ in the temperature window of −20° C. to 100° C., the peaks were defined as the first and second peaks, and both the Tg value and maximum tan δ value were recorded for both peaks.

### Example 1. EPDM-Based Thermoplastic Vulcanizate Compositions

This example illustrates that the inventive EPDM-based thermoplastic vulcanizate compositions possess better vibration dampening properties than typical thermoplastic vulcanizate compositions. Specifically, the inventive EPDM-based thermoplastic vulcanizate compositions demonstrated (1) higher tan δ peak values and (2) tan δ peak temperature windows that were broader and higher than a comparative composition.

Thermoplastic vulcanizate compositions were prepared with a plastic phase that included either (1) a cyclic olefin copolymer or (2) a blend of a cyclic olefin copolymer and a polypropylene homopolymer. The polypropylene homopolymer was either PP1 or PP2 (described above). Commercial ExxonMobil™ EPDM with 75 phr (42.86 wt % oil), Mooney viscosity of 52 MU (determined via ASTM D1646, as ML 1+4, 125° C.), ethylene content of 64 wt % (remainder propylene), and ethylidene norbornene (ENB) content of 4.5 wt % was selected as the cross-linked rubber in the thermoplastic vulcanizate compositions.

These thermoplastic vulcanizate compositions were produced on a twin-screw extruder. A co-rotating, fully intermeshing type twin screw extruder, supplied by Coperion™ Corporation, Ramsey N.J., was used following a method similar to that described in U.S. Pat. Application Publication No. 2011/0028637, incorporated herein by reference for all purposes (excepting those altered conditions identified here). EPDM was fed into the feed throat of a ZSK™ 53 extruder of L/D (length of extruder over its diameter) of about 44. The thermoplastic resin (polypropylene) was also fed into the feed throat along with other reaction rate control agents such as zinc oxide and stannous chloride. Fillers, such as clay and black MB, were also added into the extruder feed throat. Process oil was injected into the extruder at two different locations along the extruder. The curative was injected into the extruder after the rubber, thermoplastics and fillers commenced blending at about an L/D of 18.7, but after the introduction of first process oil (pre-cure oil) at about an L/D of 6.5. In some examples, the curative was injected with the process oil, which oil may or may not have been the same as the other oil introduced to the extruder or the oil the rubber was extended with. The second process oil (post-cure oil) was injected into the extruder after the curative injection at about an L/D of 26.8. Rubber crosslinking reactions were initiated and controlled by balancing a combination of viscous heat generation due to application of shear, barrel temperature set point, use of catalysts, and residence time.

The extruded materials were fed into the extruder at a rate of 70 kg/hr and the extrusion mixing was carried out at 325 revolutions per minute (RPM), unless specified. A barrel metal temperature profile in degrees Celsius, starting from barrel section 2 down towards the die to barrel section 12 of 160/160/160/160/165/165/165/165/180/180/180/180° C. (wherein the last value is for the die) was used. Low molecular weight contaminants, reaction by-products, residual moisture and the like were removed by venting through one or more vent ports, typically under vacuum, as needed. The final product was filtered using a melt gear pump and a filter screen of desired mesh size. A screw design with several mixing sections including a combination of forward convey, neutral, left handed kneading blocks and left handed convey elements to mix the process oil, cure agents and provide sufficient residence time and shear for completing the cure reaction, without slip or surging in the extruder, were used.

Tables 2A and 2B below show the compositions of the thermoplastic vulcanizate compositions. Tables 3A and 3B further below show physical properties of the same thermoplastic vulcanizate compositions.

TABLE 2A
EPDM-based thermoplastic vulcanizate compositions
(all units in phr unless otherwise noted)

| | Comparative 1 | IEx1 | IEx2 | IEx3 | IEx4 | IEx5 |
|---|---|---|---|---|---|---|
| EPDM1 | 175.0 | 175.0 | 175.0 | 175.0 | 175.0 | 175.0 |
| PP1 | 50.0 | | 15.0 | | 25.3 | 45.5 |
| PP2 | | | | | | |
| COC1 | | 50.0 | 35.0 | 101.0 | 75.8 | 55.6 |
| MB1 | 25.4 | 25.4 | 25.4 | | | |
| Clay | 12.0 | 12.0 | 12.0 | 12.0 | 12.0 | 12.0 |
| PO1 | 51.5 | 51.5 | 51.5 | 51.9 | 51.9 | 51.9 |
| RIO1 | 12.6 | 12.6 | 12.6 | 12.8 | 12.8 | 12.8 |
| MB2 | 1.7 | 1.7 | 1.7 | 1.7 | 1.7 | 1.7 |
| ZnO | 1.5 | 1.5 | 1.5 | 2.0 | 2.0 | 2.0 |
| Total | 329.7 | 329.7 | 329.7 | 356.4 | 356.4 | 356.4 |
| Plastic/EPD | 39.4 | 39.4 | 39.4 | 50.5 | 50.5 | 50.5 |
| M wt %/wt % | | | | | | |
| % COC in | 0 | 77.1 | 54.0 | 99.1 | 74.3 | 54.5 |
| plastic phase | | | | | | |

TABLE 2B
EPDM-based thermoplastic vulcanizate compositions
(all units in phr unless otherwise noted)

| | IEx6 | IEx7 | IEx8 | IEx9 | IEx10 | IEx11 |
|---|---|---|---|---|---|---|
| EPDM1 | 175.0 | 175.0 | 175.0 | 175.0 | 175.0 | 175.0 |
| PP1 | | | | | | |
| PP2 | 11.0 | 31.0 | 21.0 | 50.0 | | |
| COC1 | 120.0 | 100.0 | 110.0 | 81.0 | 70.0 | 101.0 |
| MB1 | 32.1 | 32.1 | 32.1 | 32.1 | 25.4 | |
| Clay | 12.0 | 12.0 | 12.0 | 12.0 | 12.0 | 12.0 |
| PO1 | 60.8 | 60.8 | 60.8 | 60.8 | 51.5 | 51.9 |
| RIO1 | 14.0 | 14.0 | 14.0 | 14.0 | 12.6 | 12.8 |
| MB2 | 1.7 | 1.7 | 1.7 | 1.7 | 1.7 | 1.7 |
| ZnO | 1.5 | 1.5 | 1.5 | 1.5 | 1.5 | 2.0 |
| Total | 428.1 | 428.1 | 428.1 | 428.1 | 349.7 | 386.4 |
| Plastic/EPDM | 59.9 | 59.9 | 59.9 | 59.9 | 45.9 | 56.9 |
| wt %/wt % | | | | | | |
| % COC in | 80.2 | 66.9 | 73.6 | 54.2 | 82.5 | 76.6 |
| plastic phase | | | | | | |

TABLE 3A
Physical properties of EPDM-based thermoplastic vulcanizate compositions

| | Comparative 1 | IEx1 | IEx2 | IEx3 | IEx4 | IEx5 |
|---|---|---|---|---|---|---|
| Shore A (15 s) | 77 | 46 | 58 | 44 | 61 | 70 |
| Delta Hardness | 2.9 | 9.1 | 5.9 | 20.2 | 12.5 | 7.7 |
| 100% Modulus | 3.1 | 1.3 | 1.6 | 1.0 | 1.7 | 2.2 |
| (MPa) | | | | | | |
| Tensile Strength | 7.3 | 3.3 | 4.5 | 2.9 | 4.4 | 5.2 |
| (MPa) | | | | | | |
| Elongation at break | 391 | 279 | 342 | 335 | 380 | 393 |
| (%) | | | | | | |
| Compression set, 22 | 31.4 | 17.9 | 23.5 | 41.5 | 28.3 | 28.8 |
| h, 70° C. (%) | | | | | | |
| Compression set, 22 | 24.0 | 34.2 | 31.9 | 45.1 | 38.1 | 39.1 |
| h, 23° C. (%) | | | | | | |
| Oil Swell (%) | 56 | 108 | 93 | 140 | 97 | 81 |
| LCR Viscosity (Pa · s) | 72 | 103 | 90 | 101 | 84 | 77 |
| TanD at 30° C. | 0.06 | 0.53 | 0.32 | 0.88 | 0.57 | 0.39 |
| Tan D peak value | No peak | 0.53 | 0.35 | 1.08 | 0.61 | 0.39 |
| between (0 to 60° C.) | | | | | | |
| Tan D peak | No Peak | 30 | 27 | 35 | 33 | 30 |
| temperature (° C.) | | | | | | |

TABLE 3B
Physical properties of EPDM-based thermoplastic
vulcanizate compositions

| | IEx6 | IEx7 | IEx8 | IEx9 | IEx10 | IEx11 |
|---|---|---|---|---|---|---|
| Shore A (15 s) | 66 | 73 | 70 | 80 | 50 | 68 |
| Delta Hardness | 15.6 | 11.2 | 13.4 | 7.2 | 14.6 | 14.2 |
| 100% Modulus | 2.2 | 2.7 | 2.4 | 3.4 | 1.4 | 2.1 |
| (MPa) | | | | | | |
| Tensile | 5.0 | 5.5 | 5.0 | 6.7 | 3.6 | 5.1 |
| Strength (MPa) | | | | | | |
| Elongation at | 369 | 403 | 382 | 417 | 327 | 405 |
| break (%) | | | | | | |
| Compression | 30.2 | 33.2 | 33.6 | 41.8 | 21.4 | 29.2 |
| set, 22 h, | | | | | | |
| 70° C. (%) | | | | | | |
| Compression | 60.3 | 51.1 | 53.8 | 56.9 | 50.8 | 54.6 |
| set, 22 h, | | | | | | |
| 23° C. (%) | | | | | | |
| Oil Swell (%) | 95 | 79 | 85 | 69 | 110 | 97 |
| LCR Viscosity | 85 | 74 | 79 | 65 | 94 | 84 |
| (Pa · s) | | | | | | |
| TanD at 30° C. | 0.60 | 0.48 | 0.53 | 0.37 | 0.64 | 0.55 |
| Tan D peak | 0.73 | 0.50 | 0.59 | 0.37 | 0.69 | 0.68 |
| value | | | | | | |
| between (0 to | | | | | | |
| 60° C.) | | | | | | |
| Tan D peak | 36 | 34 | 35 | 30 | 34 | 37 |
| temperature | | | | | | |
| (° C.) | | | | | | |

FIG. 1 and Tables 3A and 3B demonstrate that the inventive thermoplastic vulcanizate compositions showed a broad tan δ peak with maximum peak value in the temperature window of −20 to 60° C. As shown in FIG. 1, when compared to Comparative 1, the thermoplastic vulcanizate compositions demonstrated a higher and broader temperature window of tan δ peaks. As shown in Tables 3A and 3B, IEx3 achieved the greatest tan δ peak value of 1.08.

Delta hardness is another property that can be used to identify the damping properties of these thermoplastic vulcanizate compositions. Higher delta hardness indicates better damping performance. All of the inventive thermoplastic vulcanizate compositions demonstrated higher delta hardness (and thus better damping performance) than Comparative 1. The thermoplastic vulcanizate compositions that showed improved damping properties also possessed comparable tensile properties, compression set (or elastic properties), and processability. It was also observed that these thermoplastic vulcanizate compositions possessed scratch healing capabilities. Once a scratch was made on the thermoplastic vulcanizate compositions, the scratch disappeared with time.

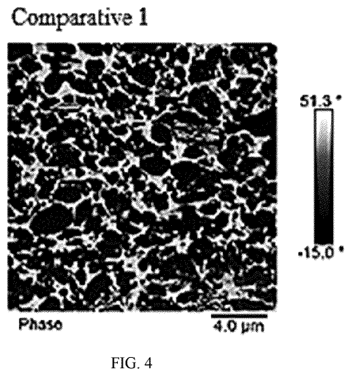

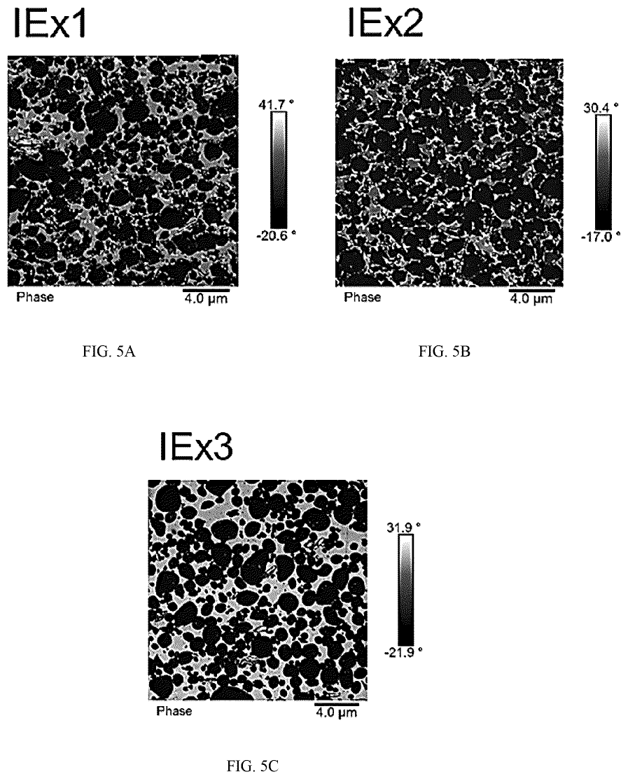

FIGS. 4, 5A, 5B, and 5C show that the thermoplastic vulcanizate compositions exhibited improved morphology and dispersion of rubber particles compared to Comparative 1, even when the plastic phase was entirely cyclic olefin copolymer with no polypropylene homopolymer (FIGS. 5A, 5C). To prepare the images shown in FIGS. 4, 5A, 5B, and 5C, samples were prepared from Comparative 1 and the thermoplastic vulcanizate compositions IEx1, IEx2, and IEx3. The samples were cut to fit into Atomic Force Microscope (AFM) sample holders (Leica, part #16702448) and then cyro-microtomed in the desired plane at −120° C. using a Leica Ultramicrotome. All samples were purged under N₂ in a desiccator before AFM imaging. The AFM images were collected using a Bruker™ Dimension Icon Atomic Force Microscope following ExxonMobil™ Established Method 120 revision 10. The scans were acquired with Bruker TESPAW-V2 cantilevers (spring constant ˜42 N/m, resonance frequency ˜320 kHz). Imaging was performed with free air amplitudes (Af) and set-points so as to maintain a net repulsive tip-sample interaction. The data channels monitored were “Height” and “Phase” with an Af of 1 V.

### Example 2. BIMS-Based Thermoplastic Vulcanizate Compositions

This example illustrates that the inventive BIMS-based thermoplastic vulcanizate compositions possess better vibration dampening properties than typical thermoplastic vulcanizate compositions. Additionally, this example illustrates that the EPDM-based thermoplastic vulcanizate compositions of Example 1 and the BIMS-based thermoplastic vulcanizate compositions of Example 2 possess similar damping, tensile, and elastic properties.

Thermoplastic vulcanizate compositions were prepared and tested similarly to those of Example 1. Commercial ExxonMobil™ specialty elastomer, which is a brominated copolymer of isobutylene and paramethylstyrene, was selected as the cross-linked rubber (BIMSM1). The rubber had a Mooney viscosity of 45 (ML1+8, 125° C., ASTMD1646) and benzylic bromine of 1.2 mol %. Stearic acid was used as a curative. MgO was added, commercially available as Maglite™ D.

Table 4 below shows the compositions of the thermoplastic vulcanizate compositions. Table 5 further below shows physical properties of the same thermoplastic vulcanizate compositions.

TABLE 4
BIMS-based thermoplastic vulcanizate compositions (all units in phr unless otherwise noted)

| | Comparative 2 | IEx12 | IEx13 | IEx14 | IEx15 | IEx16 | IEx17 | IEx18 | IEx19 |
|---|---|---|---|---|---|---|---|---|---|
| BIMSM1 | 100.0 | 100.0 | 100.0 | 100.0 | 100.0 | 100.0 | 100.0 | 100.0 | 100.0 |
| PP1 | 20.0 | 15.0 | 25.0 | | | 30.0 | 40.0 | 20.0 | 30.0 |
| PP2 | 10.0 | | 30.0 | | | | | | |
| COC1 | | 45.0 | | 75.0 | 101.0 | 71.0 | 61.0 | 81.0 | 45.0 |
| MB1 | 24.0 | 24.0 | | | | | | | |
| Clay | 7.0 | 7.0 | 7.0 | 7.0 | 7.0 | 7.0 | 7.0 | 7.0 | 7.0 |
| PO1 | 75.0 | 75.0 | 75.0 | 75.0 | 75.0 | 75.0 | 75.0 | 75.0 | 75.0 |
| RIO1 | 7.0 | 7.0 | 7.0 | 7.0 | 7.0 | 7.0 | 7.0 | 7.0 | 7.0 |
| MB2 | 1.3 | 1.3 | 1.3 | 1.3 | 1.3 | 1.3 | 1.3 | 1.3 | 1.3 |
| ZnO | 2.0 | 2.0 | 2.0 | 2.0 | 2.0 | 2.0 | 2.0 | 2.0 | 2.0 |
| Stearic Acid | 1.0 | 1.0 | 1.0 | 1.0 | 1.0 | 1.0 | 1.0 | 1.0 | 1.0 |
| MgO | 2.0 | 2.0 | 1.5 | 1.5 | 1.5 | 1.5 | 1.5 | 1.5 | 1.5 |
| Total | 249.3 | 279.3 | 249.8 | 269.8 | 295.8 | 295.8 | 295.8 | 295.8 | 269.8 |
| Plastic/EPD | 30.5 | 42.5 | 35.8 | 43.1 | 50.4 | 50.4 | 50.4 | 50.4 | 43.1 |
| M wt %/wt % | | | | | | | | | |
| % COC in | 0.0 | 60.9 | 0.0 | 99.1 | 99.3 | 69.8 | 60.0 | 79.6 | 59.4 |
| plastic | | | | | | | | | |
| phase | | | | | | | | | |

TABLE 5
Physical properties of BIMS-based thermoplastic vulcanizate compositions

| | Comparative 2 | IEx12 | Comparative 3 | IEx13 | IEx14 | IEx15 | IEx16 | IEx17 | IEx18 |
|---|---|---|---|---|---|---|---|---|---|
| Shore A (15 s) | 69.5 | 61.3 | 77.2 | 44.6 | 63.4 | 71.8 | 75.2 | 68.0 | 63.7 |
| Delta | 2.8 | 10.9 | 2.9 | 20.6 | 20.3 | 12.5 | 9.3 | 14.6 | 10.0 |
| Hardness | | | | | | | | | |
| 100% | 2.83 | 2.27 | 3.67 | 1.33 | 2.23 | 3.13 | 3.43 | 2.63 | 2.37 |
| Modulus | | | | | | | | | |
| (MPa) | | | | | | | | | |
| Tensile | 4.60 | 4.97 | 5.53 | 3.87 | 6.07 | 7.00 | 7.53 | 6.33 | 4.97 |
| Strength | | | | | | | | | |
| (MPa) | | | | | | | | | |
| Elongation at | 182 | 238 | 189 | 275 | 293 | 269 | 281 | 266 | 232 |
| break (%) | | | | | | | | | |
| Compression | 25.7 | 29.1 | 29.9 | 57.0 | 64.8 | 38.9 | 38.4 | 47.3 | 26.8 |
| set, 22 h, 70° | | | | | | | | | |
| C. (%) | | | | | | | | | |
| Compression | 17.6 | 28.7 | 18.0 | 43.0 | 40.9 | 39.6 | 41.1 | 35.6 | 37.5 |
| set, 22 h, 23° | | | | | | | | | |
| C. (%) | | | | | | | | | |
| Oil Swell (%) | 49.2 | 64.6 | 45.0 | 89.1 | 63.4 | 62.9 | 55.1 | 71.7 | 61.3 |
| LCR Viscosity | 108.0 | 130.4 | 97.4 | 178.1 | 156.6 | 138.5 | 128.5 | 150.7 | 137.0 |
| (Pa · s) | | | | | | | | | |
| TanD at 30° C. | 0.06 | 0.39 | 0.06 | 0.67 | 0.54 | 0.44 | 0.37 | 0.48 | 0.37 |
| Tan D peak | No | 0.45 | No | 1.0 | 1.2 | 0.59 | 0.45 | 0.74 | 0.41 |
| value between | Peak | | Peak | | | | | | |
| (0 to 60° C.) | | | | | | | | | |
| Tan D peak | No | 35 | No | 38 | 40 | 39 | 36 | 40 | 35 |
| temperature | Peak | | Peak | | | | | | |
| (° C.) | | | | | | | | | |

FIG. 2 and Table 5 demonstrate that the inventive thermoplastic vulcanizate compositions showed a broad tan δ peak with maximum peak value in the temperature window of 0 to 60° C. As shown in FIG. 2, when compared to Comparative 2 and 3, IEx13 demonstrated a higher and broader temperature window of tan δ peak. As shown in Table 5, IEx14 achieved the greatest tan δ peak value of 1.2. Compared to the EPDM-based thermoplastic vulcanizate compositions of Example 1, the BIMS-based thermoplastic vulcanizate compositions of Example 2 demonstrated similar tan δ peak values and temperature windows. Furthermore, the EPDM-based thermoplastic vulcanizate compositions of Example 1 and the BIMS-based thermoplastic vulcanizate compositions of Example 2 demonstrated similar damping, tensile, and elastic properties.

### Example 3. Glass Transition Temperature

This Example illustrates that rigidity of the thermoplastic vulcanizate compositions can be tuned by the norbornene content of the cyclic olefin copolymer, that the Tg of thermoplastic vulcanize compositions including cyclic olefin copolymers ranged from about 0 to about 120° C., and the Tg of the cyclic olefin copolymers in a neat condition ranged from about 30 to about 180° C. and was consistently higher than that of the thermoplastic vulcanizate compositions.

Thermoplastic vulcanizate compositions were prepared in a Brabender mixer using Vistalon™ 3666 from ExxonMobil™ (MFR 0.8 g/10 min, 230° C.) as the EPDM cross-linked rubber and pp 5341E1 from ExxonMobil™ as the polypropylene homopolymer. Various cyclic olefin copolymers with different glass transition temperatures (Tg) from TOPAS™ were selected. The cyclic olefin copolymers were TOPAS™ 6017, 6013, 5013, 8007, 9506, 9903, and E140. Vistalon™ 3666 is an oil-extended high Mooney EPDM with 75 phr oil. The curing system was phenolic resin co-catalyzed with SnCl₂/ZnO. The weight ratio of plastic (polypropylene and cyclic olefin copolymer) and EPDM was fixed at 30/70.

Thermoplastic vulcanizates were prepared by dynamically vulcanizing an elastomeric copolymer within a Brabender mixer using conventional procedures by effecting vulcanization with a phenolic resin (e.g., phenolic resin in oil curative that contains about 30 wt % phenolic resin and 70 wt % oil) in the presence of stannous chloride (SnCl₂·2H₂O) and zinc oxide (ZnO). Specifically, thermoplastic vulcanizates were prepared in a laboratory Brabender-Plasticorder (model EPL-V5502). The mixing bowls had a capacity of 85 ml with the cam-type rotors employed. The rubber was initially added to the mixing bowl that was heated to 180° C. and at 100 rpm rotor speed. Subsequently, the plastic (typically polypropylene in pellet form), clay, black MB and zinc oxide were packed in to the mixer and melt mixed for two minutes. The paraffinic oil (pre-cure oil) was then added drop-wise over a minute, and mixing was continued for 1-5 minutes (a steady torque was obtained at this time) before the addition of the phenolic resin. The phenolic resin was then added to the mixing bowl, followed by the addition of stannous chloride MB, which caused an increase in motor torque due to occurrence of the curing reaction.

Mixing was continued for about 4 more minutes, after which the molten TPV was removed from the mixer, and pressed when hot between Teflon™ plates into a sheet which was cooled, cut-up, and compression molded at about 400° F. (204.4° C.). A Wabash™ press, model 12-1212-2 TMB was used for compression molding, with 4.5″×4.5″×0.06″ mold cavity dimensions in a 4-cavity Teflon-coated mold. Material in the mold was initially preheated at about 400° F. (204.4° C.) for about 2-2.5 minutes at a 2-ton pressure on a 4″ ram, after which the pressure was increased to 10-tons, and heating was continued for about 2-2.5 minutes more. The mold platens were then cooled with water, and the mold pressure was released after cooling (about 70° C.).

As shown in FIG. 3A, thermoplastic vulcanizate compositions with TOPAS™ 6017/6013/5013 demonstrated no significant change or slightly increasing hardness with increasing cyclic olefin copolymer content. This could be explained by the fact that the Tg of these neat cyclic olefin copolymers is much higher than room temperature. For TOPAS™ 8007/9506/9903/E140, the hardness of the corresponding thermoplastic vulcanizate compositions decreased observably with increasing cyclic olefin copolymer content, making the thermoplastic vulcanize compositions feel softer.

FIG. 3B shows that the Tg of cyclic olefin copolymers in thermoplastic vulcanizate compositions was lower than that of the neat cyclic olefin copolymers, which was because the amorphous cyclic olefin copolymers were plasticized by the oil in the EPDM rubber. These results indicate the softness of cyclic olefin copolymer-based thermoplastic vulcanizate compositions could be changed by different combinations of cyclic olefin copolymers and polypropylene homopolymers. Furthermore, the Tg of cyclic olefin copolymers could be changed by either changing the molecular structure of the cyclic olefin copolymer (choosing a different cyclic olefin copolymer) or by the plasticization of the cyclic olefin copolymer (adding plasticizer in the formulation).

FIG. 3B also shows that the glass transition temperature of the cyclic olefin copolymer increased with norbornene incorporation into the backbone. The Tg of thermoplastic vulcanize compositions including cyclic olefin copolymers ranged from about 0 to about 120° C., whereas the Tg of the cyclic olefin copolymers in a neat condition ranged from about 30 to about 180° C. and was consistently higher than that of the thermoplastic vulcanizate compositions.

One or more specific embodiments of the TPV composition have been described. In an effort to provide a concise description of these embodiments, all features of an actual implementation may not be described in the specification. It should be appreciated that in the development of any such actual implementation, as in any engineering or design project, numerous implementation-specific decisions must be made to achieve the developers' specific goals, such as compliance with system-related and business-related constraints, which may vary from one implementation to another. Moreover, it should be appreciated that such a development effort might be complex and time-consuming, but would nevertheless be a routine undertaking of design, fabrication, and manufacture for those of ordinary skill having the benefit of this disclosure.

Certain terms are used throughout the description and claims to refer to particular features or components. As one skilled in the art will appreciate, different persons may refer to the same feature or component by different names. This document does not intend to distinguish between components or features that differ in name but not function.

Numbers disclosed herein are approximate values, regardless whether the word “about” or “approximate” is used in connection therewith. Whenever a numerical range with a lower limit and an upper limit is disclosed, any number falling within the range is specifically disclosed. Whenever the term “includes” is used it encompasses “includes, but is not limited to.” All documents described herein are incorporated by reference herein for purposes of all jurisdictions where such practice is allowed to the extent they are not inconsistent with this text.

Reference throughout this specification to “one embodiment,” “an embodiment,” “an embodiment,” “embodiments,” “some embodiments,” “certain embodiments,” or similar language means that a particular feature, structure, or characteristic described in connection with the embodiment may be included in at least one embodiment of the present disclosure. Thus, these phrases or similar language throughout this specification may, but do not necessarily, all refer to the same embodiment.

The embodiments disclosed should not be interpreted, or otherwise used, as limiting the scope of the disclosure, including the claims. It is to be fully recognized that the different teachings of the embodiments discussed may be employed separately or in any suitable combination to produce desired results. In addition, one skilled in the art will understand that the description has broad application, and the discussion of any embodiment is meant only to be exemplary of that embodiment, and not intended to suggest that the scope of the disclosure, including the claims, is limited to that embodiment.

What is claimed is:

1. A thermoplastic vulcanizate composition comprising:
a thermoplastic matrix comprising a cyclic olefin copolymer and an oil; and
particles dispersed in the thermoplastic matrix and comprising an at least partially cross-linked rubber;
wherein the cyclic olefin copolymer is selected to affect a vibration damping characteristic of the thermoplastic vulcanizate composition.

2. The thermoplastic vulcanizate composition of claim 1, wherein the thermoplastic vulcanizate composition exhibits a tan δ profile comprising a peak occurring between about −20° C. and about 90° C. and having a peak value between about 0.1 and about 2.0.

3. The thermoplastic vulcanizate composition of claim 1, wherein the thermoplastic vulcanizate composition has a compression set of between about 15% and about 50% at 70° C. after 22 hr of compression.

4. The thermoplastic vulcanizate composition of claim 1, wherein the thermoplastic vulcanizate composition has a hardness between about 15 and about 95 measured on a Shore A durometer hardness scale at 15 sec after indentation.

5. The thermoplastic vulcanizate composition of claim 1, wherein the thermoplastic vulcanizate composition has a hardness between about 15 and about 50 measured on a Shore D durometer hardness scale at 15 sec after indentation.

6. The thermoplastic vulcanizate composition of any claim 1, wherein the cyclic olefin copolymer has a glass transition temperature (Tg) of about 30° C. to about 200° C. in a neat condition.

7. The thermoplastic vulcanizate composition of claim 1, wherein the thermoplastic matrix comprises a blend of cyclic olefin copolymers with different glass transition temperatures.

8. The thermoplastic vulcanizate composition of claim 1, wherein the cyclic olefin copolymer comprises an ethylene-norbornene copolymer comprising from about 10 wt % to about 90 wt % norbornene.

9. The thermoplastic vulcanizate composition of claim 1, wherein the at least partially cross-linked rubber comprises a brominated isobutyl paramethyl-styrene (BIMSM) polymer, an ethylene α-olefin non-conjugated diene copolymer, an ethylene propylene diene copolymer, or a combination thereof.

10. The thermoplastic vulcanizate composition of claim 9, wherein the ethylene propylene diene copolymer comprises a diene that includes ethylidene norbornene, vinyl norbornene, or a combination thereof.

11. The thermoplastic vulcanizate composition of claim 1, wherein the at least partially cross-linked rubber is an ethylene propylene rubber, a butyl rubber, a halobutyl rubber, a halogenated copolymer of a C4 to C7 isomonoolefin and a paraalkylstyrene, or a combination thereof.

12. The thermoplastic vulcanizate composition of claim 11, wherein the butyl rubber is an isobutylene-paramethylstyrene rubber comprising from about 0.5 wt % to about 25 wt % paramethylstyrene based on a weight of the isobutylene-paramethylstyrene rubber.

13. The thermoplastic vulcanizate composition of claim 11, wherein the butyl rubber is an isobutylene-isoprene rubber comprising from about 0.5 wt % to about 30 wt % isoprene based on a weight of the isobutylene-isoprene rubber.

14. The thermoplastic vulcanizate composition of claim 11, wherein the butyl rubber is a brominated isobutylene-isoprene rubber, a chlorinated isobutylene-isoprene rubber, or a combination thereof comprising about 0.3 wt % to about 7 wt % halogen based on a weight of the butyl rubber.

15. The thermoplastic vulcanizate composition of claim 1, wherein the thermoplastic vulcanizate composition comprises the oil in an amount from about 50 to about 450 parts by weight per 100 parts rubber (about 50 to about 450 phr), wherein the oil is selected from the group consisting of mineral oil, paraffinic oil, polyisobutylene, synthetic oil, and a combination thereof.

16. The thermoplastic vulcanizate composition of claim 1, wherein the thermoplastic vulcanizate composition comprises the thermoplastic matrix in an amount from about 20 to about 500 parts by weight per 100 parts rubber (about 20 to about 500 phr).

17. The thermoplastic vulcanizate composition of claim 1, wherein the thermoplastic matrix comprises from about 1 wt % to about 100 wt % the cyclic olefin copolymer and up to 99 wt % a semi-crystalline acyclic polyolefin, and wherein the thermoplastic matrix comprises a polypropylene.

18. The thermoplastic vulcanizate composition of claim 1, wherein the thermoplastic vulcanizate composition further comprises a thermal stabilizer, a UV stabilizer, or a combination thereof.

19. The thermoplastic vulcanizate composition of claim 1, wherein the thermoplastic vulcanizate composition further comprises a filler, a slip agent, a nucleating agent, or a combination thereof, and wherein the filler comprises calcium carbonate, clay, silica, talc, titanium dioxide, carbon black, mica, wood flour, or a combination thereof.

20. The thermoplastic vulcanizate composition of claim 1, further comprising a cure system, and wherein the cure system comprises a phenolic resin, a peroxide, a maleimide, a hexamethylene diamine carbamate, a silicon-based curative, a silane-based curative, a metal oxide, a sulfur-based curative, or a combination thereof.
